(19) United States
(12) Patent Application Publication
(10) Pub. No.: US 2011/0220817 A1
(43) Pub. Date: Sep. 15, 2011

(54) METHOD OF REDUCING THE DISTORTION OF THE ELECTROMAGNETIC FIELD

(76) Inventor: John W. Moore, Wilmington, DE (US)

(21) Appl. No.: 13/058,575

(22) PCT Filed: Jul. 23, 2009
(86) PCT No.: PCT/US09/51514

§ 371 Date: May 5, 2011

Related U.S. Application Data
(60) Provisional application No. 61/088,158, filed on Aug. 12, 2008.

(51) Int. Cl. G21K 1/00

(52) U.S. Cl. 250/505.1

(57) ABSTRACT

Methods and devices are disclosed for minimizing the distortion (or “regularizing”) of the electromagnetic field (EMF) associated with a subject caused by higher frequency electromagnetic fields surrounding the subject by imprinting objects placed in contact with the subject. The methods of the invention provide, inter alia, improvements in strength, stress potentiation, flexibility, stability, and sleep.

### CROSS REFERENCE TO RELATED APPLICATIONS

This application claims the benefit of U.S. Application No. 61/088,158 filed Aug. 12, 2008, the entire disclosure of which is incorporated herein by reference.

### FIELD OF THE INVENTION

The present invention generally relates to electromagnetic fields and holography. More particularly, the invention relates to minimizing the distortion (or regularizing) of the electromagnetic field associated with a subject.

### BACKGROUND OF THE INVENTION

Living things, including humans, are defined by electromagnetic fields (EMF) that resonate at a natural frequency of about 7.8 cycles/second. Research has shown that toxic fields of energy are created by electro-magnetic pollution, such as electromagnetic fields caused by the devices and systems, including, but not limited to, cellular telephones, home telephones, automobiles, microwave ovens, computers, and electrical grids in their homes and office buildings. These devices resonate at lower frequencies (direct current) or at much higher frequencies (about 50 to 60 cycles/second alternating current) relative to the natural frequency of the earth, which causes distortion of the natural frequency of the EMF associated with an individual.

Others have recognized the need to regularize the EMF of living things. The prior art generally describes the use of certain objects, such as jewelry, wristbands, socks, and other garments or accessories, worn close to the body to regularize the EMF and/or to improve the physical performance (for example, enhanced performance in golf and baseball) or physical state (for example, to improve circulation or reduce pain) of the user. See, for example, U.S. Pat. No. 5,158,526, U.S. Pat. No. 6,773,391, U.S. Pat. No. 6,461,375, US 2002/0156340, US 2003/118615, US 2004/0057983, and WO 2004/078091.

The methods and devices of the present invention are directed toward these, as well as other, important ends.

### SUMMARY OF THE INVENTION

The invention relates generally to minimizing the distortion (or “regularizing”) of the EMF associated with a subject caused by man-made electromagnetic fields surrounding the subject. The prior art generally describes the use of certain objects, such as jewelry, wristbands, socks, and other garments or accessories, worn close to the body to regularize the EMF and improve the physical performance (for example, enhanced performance in golf and baseball) or physical state (for example, to improve circulation or reduce pain) of the user. The invention contemplates the use of these objects (“EMF regularizing device”) but in different manner than the prior art with unexpected results. In certain embodiments, the physical performance of the user (including an increase in strength, stability, and/or flexibility, and an increase in the rate of stress potentiation), can be enhanced by using an EMF regularizing device to “imprint” garments, footwear, accessories, linens, and/or floor coverings by placing the EMF regularizing device in close proximity to the garments, footwear, accessories, linens, and/or floor coverings for a minimum period of time and then wearing or using the imprinted product. In other embodiments, sleep can be improved by directly contacting the EMF regularizing device with the subject while the subject attempts to fall asleep and/or is sleeping or indirectly by imprinting garments, footwear, accessories, linens, and/or floor coverings, which are in contact with the subject while the subject attempts to fall asleep and/or is sleeping.

Accordingly, in one embodiment, the invention is directed to methods of reducing the distortion of the electromagnetic field associated with a subject caused by an electromagnetic field from an external source, comprising the step of:

contacting a regularizing device to a component selected from the group consisting of a garment, a linen, a floor covering, or a combination thereof for a period of time sufficient to imprint said component to produce an imprinted component; and

contacting said imprinted component with said subject;

wherein said regularizing device comprises at least one non-metallic, non-conductive or semi-conductive, non-magnetic, and non-energized circuit.

In another embodiment, the invention is directed to methods of increasing strength of a muscle of a subject during use, comprising the step of:

contacting a regularizing device to a component selected from the group consisting of a garment, a linen, a floor covering, or a combination thereof for a period of time sufficient to imprint said component to produce an imprinted component; and

contacting said imprinted component to said subject during said use of said muscle;

wherein said regularizing device comprises at least one non-metallic, non-conductive or semi-conductive, non-magnetic, and non-energized circuit.

In other embodiments, the invention is directed to methods of increasing the rate of stress potentiation of a subject during a physical activity, comprising the step of:

contacting a regularizing device to a component selected from the group consisting of a garment, a linen, a floor covering, or a combination thereof for a period of time sufficient to imprint said component to produce an imprinted component; and

contacting said imprinted component to said subject during said physical activity;

wherein said regularizing device comprises at least one non-metallic, non-conductive or semi-conductive, non-magnetic, and non-energized circuit.

In yet other embodiments, the invention is directed to methods of improving stability of a subject during a physical activity, comprising the step of:

contacting a regularizing device to a component selected from the group consisting of a garment, a linen, a floor covering, or a combination thereof for a period of time sufficient to imprint said component to produce an imprinted component; and

contacting said imprinted component with said subject during said physical activity;

wherein said regularizing device comprises at least one non-metallic, non-conductive or semi-conductive, non-magnetic, and non-energized circuit.

In still other embodiments, the invention is directed to methods of improving flexibility of a subject during a physical activity, comprising the step of:

contacting a regularizing device to a component selected from the group consisting of a garment, a linen, a floor covering, or a combination thereof for a period of time sufficient to imprint said component to produce an imprinted component; and

contacting said imprinted component with said subject during said physical activity;

wherein said regularizing device comprises at least one non-metallic, non-conductive or semi-conductive, non-magnetic, and non-energized circuit.

In further embodiments, the invention is directed to methods of improving sleep in a subject, comprising the step of:

contacting a regularizing device to a component selected from the group consisting of a garment, a linen, a floor covering, or a combination thereof for a period of time sufficient to imprint said component to produce an imprinted component; and

contacting said imprinted component with said subject while said subject attempts to fall asleep, is sleeping, or a combination thereof;

wherein said regularizing device comprises at least one non-metallic, non-conductive or semi-conductive, non-magnetic, and non-energized circuit.

In certain embodiments, the invention is directed to devices for imprinting an object selected from the group consisting of a garment, linen, floor covering, and combinations thereof, comprising:

at least one non-metallic, non-conductive or semi-conductive, non-magnetic, and non-energized circuit;

wherein said circuit comprises:

a substrate; and

a printed geometric pattern or shape on said substrate;

wherein said device reduces the distortion of the electromagnetic field associated with a subject in contact with said object caused by an electromagnetic field from an external source.

In certain other embodiments, the invention is directed to garments, comprising:

a substrate selected from the group consisting of paper, fibrous material, polymer, woven fabric, non-woven, glass, wood, ceramic, leather, ceramic, and composites thereof; and

at least one non-metallic, non-conductive or semi-conductive, non-magnetic, and non-energized circuit comprising at least one printed geometric pattern or shape on said substrate;

wherein said garment reduces distortion of the electromagnetic field associated with a subject caused by an electromagnetic field from an external source, when said garment is worn by said subject; and

wherein said garment is other than jewelry.

In certain embodiments, the invention is directed to linens, comprising:

a substrate selected from the group consisting of paper, fibrous material, polymer, woven fabric, non-woven, glass, wood, ceramic, leather, and composites thereof; and

at least one non-metallic, non-conductive or semi-conductive, non-magnetic, and non-energized circuit comprising at least one printed geometric pattern or shape on said substrate;

wherein said linen reduces the distortion of the electromagnetic field associated with a subject caused by an electromagnetic field from an external source, when said linen is in contact with said subject.

In certain embodiments, the invention is directed to floor coverings, comprising:

a substrate selected from the group consisting of paper, fibrous material, polymer, woven fabric, non-woven, glass, wood, ceramic, leather, and composites thereof; and

at least one non-metallic, non-conductive or semi-conductive, non-magnetic, and non-energized circuit comprising at least one printed geometric pattern or shape on said substrate;

wherein said floor covering reduces the distortion of the electromagnetic field associated with a subject caused by an electromagnetic field from an external source, when said floor covering is in contact with said subject.

In yet other embodiments, the invention is directed to system, comprising:

at least one regularizing device described herein; and

at least one device having an electromagnetic field.

In other embodiments, the invention is directed to methods of improving a biological effect in a subject, comprising the steps:

contacting a regularizing device to a component selected from the group consisting of a garment, a linen, a floor covering, or a combination thereof for a period of time sufficient to imprint said component to produce an imprinted component; and

contacting said imprinted component with said subject while said subject is administered, via ingestion or via contact to a body part of said subject, a composition comprising at least one organic compound selected from the group consisting of trans-3,5,4′-trihydroxystilbene, a levorotary organic compound, and a dextrorotary organic compound, provided said organic compounds have the same optical rotation;

wherein said regularizing device comprises at least one non-metallic, non-conductive or semi-conductive, non-magnetic, and non-energized circuit; and

wherein said biological effect is selected from the group consisting of:
an increase in strength of a muscle;
an increase in the rate of stress potentiation of a subject during a physical activity;
an improvement in stability of said subject during a physical activity;
an improvement in flexibility of said subject during a physical activity; and
an improvement in sleep in said subject.

In yet other embodiments, the invention is directed to methods of improving a biological effect in a subject, comprising the steps:

contacting a regularizing device to a said subject while said subject is administered, via ingestion or via contact to a body part of said subject, a composition comprising at least one organic compound selected from the group consisting of trans-3,5,4′-trihydroxystilbene, a levorotary organic compound, and a dextrorotary organic compound, provided said organic compounds have the same optical rotation;

wherein said regularizing device comprises at least one non-metallic, non-conductive or semi-conductive, non-magnetic, and non-energized circuit; and

wherein said biological effect is selected from the group consisting of:

an increase in strength of a muscle;

an increase in the rate of stress potentiation of a subject during a physical activity;

an improvement in stability of said subject during a physical activity;

an improvement in flexibility of said subject during a physical activity; and

an improvement in sleep in said subject.

In yet other embodiments, the invention is directed to methods of improving a biological effect in a subject, comprising the steps:

contacting a coil device to a component selected from the group consisting of a garment, a linen, a floor covering, or a combination thereof for a period of time sufficient to imprint said component to produce an imprinted component;

removing said coil device from said component prior to said contacting said imprinted component with said subject; and

contacting said imprinted component with said subject;

wherein said coil device comprises at least one metallic, non-energized circuit; and

wherein said biological effect is selected from the group consisting of:
an increase in strength of a muscle;
an increase in the rate of stress potentiation of a subject during a physical activity;
an improvement in stability of said subject during a physical activity;
an improvement in flexibility of said subject during a physical activity; and
an improvement in sleep in said subject.

In yet other embodiments, the invention is directed to garments, comprising:

a substrate;

wherein said garment is a shirt, pants, underwear, outerwear, footwear, headwear, swimwear, belt, a glove, a headband, or a wristband;

wherein said garment increases strength or flexibility by at least about 2%, on average, in a group of at least five subjects, when said garment is worn by said subjects who have reached a maximum value in said strength or said flexibility without wearing said garment.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 displays graphically the potentiation in leg extension strength by the treated socks eight days after their treatment, compared to the best stress-potentiated strength possible on the preceding day wearing the same type socks untreated.

FIG. 2 shows the regularizing device (a piece of paper having a geometric pattern printed thereon) and FIG. 3 shows another regularizing device (scanned and reprinted copy of geometric pattern from FIG. 2) used in the Examples.

FIG. 4 shows the results of the sit and reach test carried out in Example 14.

FIG. 5 displays graphically the potentiation in hand grip strength by the treated socks as a function of the time of EMF imprinting of the socks prior to the hand grip strength, as measured in Example 18.

FIG. 6 displays graphically the potentiation in hand grip strength by the treated socks as a function of the time of EMF imprinting of the socks prior to the hand grip strength, as measured in Example 18. This figure is annotated to show the three key ranges of results.

### DETAILED DESCRIPTION OF THE INVENTION

As employed above and throughout the disclosure, the following terms, unless otherwise indicated, shall be understood to have the following meanings.

As used herein, the singular forms “a,” “an,” and “the” include the plural reference unless the context clearly indicates otherwise.

As used herein, the term “about,” when referring to a measurable value such as an amount, a temporal duration, and the like, is meant to encompass variations of ±20%, preferably ±10%, more preferably ±5%, even more preferably ±1%, and yet even more preferably ±0.1% from the specified value, as such variations are appropriate to perform the disclosed methods.

As used herein, the term “electromagnetic field” or “EMF” refers to the physical field produced by electrically charged objects. The field can be viewed as the combination of an electric field and a magnetic field. The electric field is produced by stationary charges, and the magnetic field by moving charges (currents).

As used herein, the term “garment” refers to any article of clothing or clothing accessory worn by a person, including, but not limited to shirt, pants, underwear, outerwear, footwear, headwear, swimwear, belts, gloves, headbands, wristbands, and jewelry, unless otherwise noted. The garment can include a label, a hang tag, or both.

As used herein, the term “hanger” refers to a frame, sometimes shoulder-shaped, and generally with a hook at the top, usually of wire, wood, or plastic, for draping and hanging a garment when not in use. The frame can open or covered with a suitable material, such as paper, wood, plastic, polymeric film, metal, leather, non-woven, fabric, or a combination thereof.

As used herein, the term “shoe tree” refers to a device approximating the shape of a foot that is placed inside a shoe, boot, or other footwear to preserve its shape. The device is generally formed from wood, plastic, wood, or a combination thereof.

As used herein, the term “shoe insole” refers to an interior bottom of a shoe or similar footwear, which sits directly beneath the foot. The insole may be replaceable.

As used herein, the term “linen,” as used herein refers to any article of fabric or material used on a bed or similar furniture, including, but not limited to a sheet, pillowcase, blanket, throw, afghan, sleeping bag, baby bunting, quilt, comforter, mattress cover, and the like.

As used herein, the term “floor covering,” as used herein refers to any material used on a floor or similar location, including, but not limited to a carpet, a rug, a mat (including a bath mat, shower mat, chair mat, and desk mat), and the like.

As used herein, the term “contacting” refers to the direct physical touching of at least two surfaces for a period of time. As used herein, it also meant to include to any action where at least two surfaces are held in close proximity, i.e., less than about 6 inches, preferably less than about 2 inches, more preferably less than about 1 inch, and yet even more preferably less than about 0.1 inch apart for at least a portion of each other for a period of time. In embodiments where the contacting step involves directly or indirectly touching the imprinted component to the subject, the direct or indirect touching relates to the subject and not where the effect is necessarily observed. For example, the imprinted component may be a pair of socks or a hat but the effect observed is an improvement in leg strength or stress potentiation in the leg muscles or flexibility or balance or a combination thereof or an improvement in grip strength in the hand muscles. With respect to the period of time, the duration of contact preferably ranges from at least about fifteen minutes to one hour, but can preferably range from a few minutes to overnight (about 12 hours) to several days.

As used herein, the term “regularizing,” with respect to electromagnetic fields, refers to minimizing the distortion of the natural resonance associated with an object caused by one or more external sources.

As used herein, the term “imprinting” refers to the process of regularizing the electromagnetic field associated with an inanimate object and then using the inanimate object to regularize the electromagnetic field associated with a subject. In preferred embodiments, the imprinting effect lasts at least one hour, more preferably, at least about one day, even more preferably, at least about two days, yet even more preferably, at least about one week, more preferably still, at least about one month, yet more preferably, at least about four months, even more preferably, at least about six months, and most preferably permanently.

As used herein, the term “circuit” refers to a generally circular or curved path, which may or may not be closed.

As used herein, the term “geometric pattern” refers a pattern of geometric shapes that repeat in a predictable manner.

As used herein, the term “geometric shape” refers a part of space occupied by the object as determined by its external boundary.

As used herein, the term “Golden spiral” refers to a logarithmic spiral whose growth factor b is related to φ, the Golden ratio. Specifically, a Golden spiral gets wider (or further from its origin) by a factor of φ for every quarter turn it makes.

As used herein, the term “Fibonacci spiral” refers to an approximation of a Golden spiral. A Fibonacci spiral is not a true logarithmic spiral. Every quarter turn a Fibonacci spiral gets wider not by φ, but by a changing factor related to the ratios of consecutive terms in the Fibonacci sequence. The ratios of consecutive terms in the Fibonacci series approach φ, so that the two spirals are very similar in appearance.

As used herein, the term “concentric set of curved open-ended lines” refers to at least two curved open-ended lines where the curved open-ended lines share a common center and do not intersect. Preferably, the curved lines form a general oval or circular shape. More preferably, the curved lines form a generally circular shape. Preferably, the openings of the curved open-ended lines of adjacent curved open-ended lines are offset by about 180°.

As used herein, the term “stress potentiation” refers to the transient increase realized by a subject, especially a mammal, in muscle strength or flexibility caused by repeating a physical act to reach maximum output.

As used herein, the term “stability” refers to the physical ability to balance and control positions and movement, including the ability to stand, walk, and sit without excessive extraneous motion and to hold positions for a minimum duration.

As used herein, the term “physical activity” refers to any bodily movement or position produced by skeletal muscles that results in an expenditure of energy, including standing, sitting, walking, running, exercising, and the like.

As used herein, the term “flexibility” refers to the measurement of the achievable distance between the flexed position and the extended position of a particular joint or muscle group.

As used herein, the term “subject” refers to any living thing, including a mammal, especially a human.

As used herein, the term “healthy” refers to any subject not suffering from substantial muscle weakness.

As used herein, the term “regularizing device” refers to a non-metallic, non-conductive or semi-conductive, non-magnetic, and non-energized device that is capable of minimizing the distortion of the natural resonance associated with an object caused by one or more external sources and contains at least one circuit, where the circuit includes a geometric pattern or shape printed on a substrate. Suitable regularizing devices may be prepared as described herein using suitable substrates, including but not limited to, paper and other fibrous materials, polymeric films and members, woven fabric, non-wovens, glass, wood, leather, ceramic, or a composite thereof.

The invention relates generally to minimizing the distortion (or “regularizing”) of the EMF associated with a subject caused by higher frequency electromagnetic fields surrounding the subject. The prior art generally describes the use of certain objects, such as jewelry, wristbands, socks, and other garments or accessories, worn close to the body to regularize the EMF and improve the physical performance (for example, strength) or physical state (for example, to improve circulation or reduce pain) of the user. The invention contemplates the use of these objects (“EMF regularizing device”) but in different manner than the prior art with unexpected results. In certain embodiments, the physical performance of the user (including an increase in strength and an increase in the rate of stress potentiation), can be enhanced by using an EMF regularizing device to “imprint” garments, footwear, accessories, linens, and floor coverings by placing the EMF regularizing device in close proximity to the garments, footwear, accessories, linens, and floor coverings for a minimum period of time and then wearing or using the imprinted product. In other embodiments, sleep can be improved by directly contacting the EMF regularizing device with the subject while the subject attempts to fall asleep and/or is sleeping or indirectly by imprinting garments, footwear, accessories, linens, and/or floor coverings, which are in contact with the subject while the subject attempts to fall asleep and/or is sleeping.

Accordingly, in one embodiment, the invention is directed to methods of reducing the distortion of the electromagnetic field associated with a subject caused by an electromagnetic field from an external source, comprising the step of:

contacting a regularizing device to a component selected from the group consisting of a garment, a linen, a floor covering, or a combination thereof for a period of time sufficient to imprint said component to produce an imprinted component; and

contacting said imprinted component with said subject;

wherein said regularizing device comprises at least one non-metallic, non-conductive or semi-conductive, non-magnetic, and non-energized circuit.

In certain embodiments, the component comprises a material selected from paper and other fibrous materials, polymeric films and members, woven fabric, non-wovens, glass, wood, leather, ceramic, and composites thereof.

In another embodiment, the invention is directed to methods of increasing strength of a muscle of a subject during use, comprising the step of:

contacting a regularizing device to a component selected from the group consisting of a garment, a linen, a floor covering, or a combination thereof for a period of time sufficient to imprint said component to produce an imprinted component; and

contacting said imprinted component to said subject during said use of said muscle;

wherein said regularizing device comprises at least one non-metallic, non-conductive or semi-conductive, non-magnetic, and non-energized circuit.

In certain embodiments, the regularizing device may in the form of an adhesive label or a hang tag.

In other embodiments, the invention is directed to methods increasing the rate of stress potentiation of a subject during a physical activity, comprising the step of:

contacting a regularizing device to a component selected from the group consisting of a garment, a linen, a floor covering, or a combination thereof for a period of time sufficient to imprint said component to produce an imprinted component; and

contacting said imprinted component to said subject during said physical activity;

wherein said regularizing device comprises at least one non-metallic, non-conductive or semi-conductive, non-magnetic, and non-energized circuit.

In yet other embodiments, the invention is directed to methods of improving stability of a subject during a physical activity, comprising the step of:

contacting a regularizing device to a component selected from the group consisting of a garment, a linen, a floor covering, or a combination thereof for a period of time sufficient to imprint said component to produce an imprinted component; and

contacting said imprinted component with said subject during said use;

wherein said regularizing device comprises at least one non-metallic, non-conductive or semi-conductive, non-magnetic, and non-energized circuit.

In still other embodiments, the invention is directed to methods of improving flexibility of a subject during a physical activity, comprising the step of:

contacting a regularizing device to a component selected from the group consisting of a garment, a linen, a floor covering, or a combination thereof for a period of time sufficient to imprint said component to produce an imprinted component; and

contacting said imprinted component with said subject during said physical activity;

wherein said regularizing device comprises at least one non-metallic, non-conductive or semi-conductive, non-magnetic, and non-energized circuit.

In further embodiments, the invention is directed to methods of improving sleep in a subject, comprising the step of:

contacting a regularizing device to a component selected from the group consisting of a garment, a linen, a floor covering, or a combination thereof for a period of time sufficient to imprint said component to produce an imprinted component; and

contacting said imprinted component with said subject while said subject attempts to fall asleep, is sleeping, or a combination thereof;

wherein said regularizing device comprises at least one non-metallic, non-conductive or semi-conductive, non-magnetic, and non-energized circuit.

In certain preferred embodiments, the methods further comprise the step of:

removing said regularizing device from said component prior to said contacting said imprinted component with said subject.

In certain preferred embodiments, the step of contacting the regularizing device to the component is carried out in the presence of at least one device having an electromagnetic field, such as a battery. In such embodiments, the imprinting is accelerated. It was determined that the device having an electromagnetic field, such as a battery, does not regularize on its own. For example, during the imprinting step, when a battery is placed in the presence of the regularizing device for at least about three minutes, the component, which may be any material other than a conductive material, 85% of the maximum effect of the imprinting is achieved. During the imprinting step, when a battery is placed in the presence of the regularizing device for between about three and about 30 minutes, the maximum effect of the imprinting is achieved. Exact alignment or registry of the pattern on the regularizing device in repeated treatments is not required. This imprinting on a component appears to endure for at least about 1.5 years in some cases. There is also imprinting on the skin of the tester of the imprinted component that lasts less than about an hour, generally less than about 5 minutes, and appears to dissipate quickly. While not wishing to be bound by theory, it is believed that this dissipation is as a result of the changing and renewing of living cells. Metals do not imprint. While not wishing to be bound by theory, it is believed that the inability to imprint metals is because their outer shell electrons are not fixed in a molecular structure and are freely moving through the materials and thus their electromagnetic fields cannot be regularized.

In certain preferred embodiments, the step of contacting said imprinted component with said subject is carried out in the presence of at least one device having an electromagnetic field, such as a battery, however it is not required to see the benefit.

Suitable batteries for use in the embodiments of the invention include, but are not limited to, primary batteries and secondary batteries, used in a number of man-made devices, including but not limited to cellular telephones (including iPhone), personal digital assistants, electronic watches, and electronic car door openers, which are typically carried or worn on a person in pockets or in a carrying bag. Suitable batteries also include paper batteries wherein said battery is printed on said garment or is printed and attached on said garment. The paper batteries are prepared by a silk-screen printing method where the battery is built up of different layers, such a zinc anode and a manganese cathode, among others, such as those developed by the Fraunhofer Research Institution for Electronic Nano Systems EANS together with TU Chemnitz and Menippos GmbH. For the paper batteries, zinc and manganese react with one another and produce electricity. Suitable primary batteries include zinc-carbon batteries and alkaline batteries. Suitable secondary batteries include wet cell types (such as lead-acid batteries, sealed valve regulated lead acid (VRLA) batteries, gel batteries (or gel cells), and absorbed glass mat (AGM) batteries) and dry cell types (such as nickel-cadmium (NiCd), nickel metal hydride (NiMH) and lithium-ion (Li-ion) cells).

As used in herein, the phrase “carried out in the presence of” means that the device having an electromagnetic field is placed in direct physical contact for a period of time with the regularizing device and/or component to be imprinted. As used herein, it is also meant to include to any action where the device having an electromagnetic field and the regularizing device and/or component to be imprinted are held in close proximity, i.e., less than about 6 inches, preferably less than about 2 inches, more preferably less than about 1 inch, and yet even more preferably less than about 0.1 inch apart for at least a portion of each other for a period of time. With respect to the period of time, the duration preferably ranges from at least about fifteen minutes to one hour, but can preferably range from a few minutes to overnight (about 12 hours) to several days.

In certain preferred embodiments, the imprinted component is positioned over the muscle or muscle group being used or potentiated or tested. As used herein, “positioned over the muscle or muscle group” means placing the imprinted component within about 6 inches of the muscle or muscle group being used, preferably less than about 4 inches, more preferably less than about 2 inches, even more preferably less than about 1 inch, and most preferably touching the skin in the area of the body where the muscle or muscle group being used. For example, it is preferably to position the imprinted component over the muscles in the forearm for the handgrip test, over the chest muscles for the chest press test, and over the lower and/or upper leg muscles for the leg extension test.

In certain preferred embodiments, the device having an electromagnetic field used in the step of contacting the imprinted component with the subject is the same device or of the same device type as the device having an electromagnetic field used in the step of contacting the regularizing device to the component.

In certain embodiments, the step of contacting said imprinted component with said subject is carried out in the absence of a device having an electromagnetic field.

As used in herein, the phrase “carried out in the absence of” means that the device having an electromagnetic field is not placed in direct physical contact for a period of time with the imprinted component and/or subject. As used herein, it also meant to include to any action where the device having a small electric field and the imprinted component and/or the subject are no closer than about 6 inches, preferably greater than about one foot, more preferably greater than about 5 feet, and yet even more preferably greater than about 10 feet.

In certain embodiments, the invention is directed to devices for imprinting an object selected from the group consisting of a garment, linen, floor covering, and combinations thereof, comprising:

at least one non-metallic, non-conductive or semi-conductive, non-magnetic, and non-energized circuit;

wherein said circuit comprises:

a substrate; and

a printed geometric pattern or shape on said substrate;

wherein said device reduces the distortion of the electromagnetic field associated with a subject in contact with said object caused by an electromagnetic field from an external source.

In certain preferred embodiments, the device for imprinting is a hanger, shoe tree, shoe insole, an adhesive label, or a hang tag.

In certain other embodiments, the invention is directed to garments, comprising:

a substrate selected from the group consisting of paper, fibrous material, polymer, woven fabric, non-woven, glass, wood, ceramic, leather, and composites thereof; and

at least one non-metallic, non-conductive or semi-conductive, non-magnetic, and non-energized circuit comprising at least one printed geometric pattern or shape on said substrate;

wherein said garment reduces distortion of the electromagnetic field associated with a subject caused by an electromagnetic field from an external source, when said garment is worn by said subject; and

wherein said garment is other than jewelry.

In certain embodiments, the invention is directed to linens comprising:

a substrate selected from the group consisting of paper, fibrous material, polymer, woven fabric, non-woven, glass, wood, ceramic, leather, and composites thereof; and

at least one non-metallic, non-conductive or semi-conductive, non-magnetic, and non-energized circuit comprising at least one printed geometric pattern or shape on said substrate;

wherein said linen reduces the distortion of the electromagnetic field associated with a subject caused by an electromagnetic field from an external source, when said linen is in contact with said subject.

In certain embodiments, the invention is directed to floor coverings, comprising:

a substrate selected from the group consisting of paper, fibrous material, polymer, woven fabric, non-woven, glass, wood, ceramic, leather, and composites thereof; and

at least one non-metallic, non-conductive or semi-conductive, non-magnetic, and non-energized circuit comprising at least one printed geometric pattern or shape on said substrate;

wherein said floor covering reduces the distortion of the electromagnetic field associated with a subject caused by an electromagnetic field from an external source, when said floor covering is in contact with said subject.

In certain preferred embodiments, the circuit comprises:

a substrate selected from the group consisting of paper, fibrous material, polymer, woven fabric, non-woven, glass, wood, ceramic, leather, and composites thereof; and

a printed geometric pattern or shape on said substrate.

In certain especially preferred embodiments, said printed geometric pattern or shape is a concentric set of curved open-ended lines. In certain especially preferred embodiments, said printed geometric pattern or shape is a spiral pattern, particularly where said spiral pattern follows the Golden spiral or a Fibonacci spiral.

In certain embodiments, the printed geometric pattern or shape is formed from at least one polymeric composition. In certain embodiments, the printed geometric pattern or shape is made using an ink jet printer. In certain embodiments, the printed geometric pattern or shape is not visually detectable by the unaided human eye. As used herein, “unaided” refers to without the use of a microscope or other magnifying device.

Suitable substrates useful in the regularizing devices and the methods of the invention include paper, fibrous material, polymer, woven fabric, non-woven, glass, wood, ceramic, leather, and composites thereof.

In certain embodiments, the regularizing device is detachably connected to said component.

In certain embodiments, especially those related to increasing muscle strength or potentiation, the subject is healthy.

In certain embodiments of the invention, the regularizing device is contacted with said component to be imprinted for at least 5 minutes, preferably at least 10 minutes, more preferably, at least 15 minutes, even more preferably at least 45 minutes, more preferably at least one hour, even more preferably two hours, yet even more preferably four hours and in some cases 24 hours. With respect to this imprinting step, there does not appear to be an upper limit to how long the regularizing device may be in contact with the component to be imprinted.

In certain embodiments of the invention, the imprinting effect lasts at least one hour, more preferably, at least about one day, even more preferably, at least about two days, yet even more preferably, at least about one week, more preferably still, at least about one month, yet more preferably, at least about four months, even more preferably, at least about six months, and most preferably permanently.

In yet other embodiments, the invention is directed to system, comprising:

at least one regularizing device described herein; and

at least one device having an electromagnetic field.

In certain preferred embodiments, the device having an electromagnetic field is a battery as described herein.

It has been discovered that the regularizing device of the invention may be used to accelerate the realization of the beneficial biological effect of the devices such as those disclosed in US 2004/0057983, the disclosure of which is incorporated herein by reference. It has also been discovered that the regularizing device may be used to accelerate the realization of the beneficial biological effect of the materials used in the devices disclosed in US 2004/0057983 applied directly to the skin or ingested rather than supplied in an enclosure.

Accordingly, the invention is directed, in part, to methods of improving a biological effect in a subject, comprising the steps:

contacting a regularizing device to a component selected from the group consisting of a garment, a linen, a floor covering, or a combination thereof for a period of time sufficient to imprint said component to produce an imprinted component; and

contacting said imprinted component with said subject while said subject is administered, via ingestion or via contact to a body part of said subject, a composition comprising at least one organic compound selected from the group consisting of trans-3,5,4′-trihydroxystilbene, a levorotary organic compound, and a dextrorotary organic compound, provided said organic compounds have the same optical rotation;

wherein said regularizing device comprises at least one non-metallic, non-conductive or semi-conductive, non-magnetic, and non-energized circuit; and

wherein said biological effect is selected from the group consisting of:
an increase in strength of a muscle;
an increase in the rate of stress potentiation of a subject during a physical activity;
an improvement in stability of said subject during a physical activity;
an improvement in flexibility of said subject during a physical activity; and
an improvement in sleep in said subject.
   In certain preferred embodiments, the subject is administered additional quantities of the compositions comprising at least one organic compound, which have been depleted, to extend the benefit of the method of the invention.

In yet other embodiments, the invention is directed to methods of improving a biological effect in a subject, comprising the steps:

contacting a regularizing device to a said subject while said subject is administered, via ingestion or via contact to a body part of said subject, a composition comprising at least one organic compound selected from the group consisting of trans-3,5,4′-trihydroxystilbene, a levorotary organic compound, and a dextrorotary organic compound, provided said organic compounds have the same optical rotation;

wherein said regularizing device comprises at least one non-metallic, non-conductive or semi-conductive, non-magnetic, and non-energized circuit; and

wherein said biological effect is selected from the group consisting of:

an increase in strength of a muscle;

an increase in the rate of stress potentiation of a subject during a physical activity;

an improvement in stability of said subject during a physical activity;

an improvement in flexibility of said subject during a physical activity; and

an improvement in sleep in said subject.

In certain preferred embodiments, the subject is administered additional quantities of the compositions comprising at least one organic compound, which have been depleted, to extend the benefit of the method of the invention.

As used herein with respect to the composition comprising the organic compound, the phrase “while said subject is administered” includes administration of the organic compound(s) via ingestion and/or via contact to a body part of the subject prior to, simultaneously with, or subsequent to the step of contacting the imprinted component with the subject or the step of contacting the regularizing device to the subject. If not administered simultaneously with the contacting of the imprinted component or the regularizing device, the composition may be administered shortly before (for example, less than one hour prior to) or shortly after (for example, less than about one hour after, preferably less than about 15 minutes after) the step of contacting the imprinted component with the subject or the step of contacting the regularizing device to the subject. Preferably, the contacting step with the imprinted component is maintained for a period of time sufficient to enhance the biological effect of the optical rotary composition, such as at least about 15 minutes, more preferably at least about 30 minutes, even more preferably at least about one hours, and yet more preferably at least about two hours.

In certain embodiments, the levorotary organic compound is an amino acid selected from the group consisting of L-alanine, L-arginine, L-aspargine, L-aspartic Acid, L-carnitine, acetyl-L-carnitine, L-camitine L-tartrate, L-camitine magnesium citrate, L-citrulline, L-cysteine, L-cystine, L-GABA, L-glutamic acid, L-glutamine, glutathione peroxidase, L-glycine, L-histidine, hydroxyglutamic acid, hydroxyproline, L-isoleucine, L-leucine, norleucine, L-lysine, L-methionine, L-ornithine, L-valine, L-phenylalanine, L-proline, L-serine, L-taurine, L-threonine, L-tryptophan, L-tyrosine, and combinations thereof.

In certain embodiments, the dextrorotary organic compound is an amino acid selected from a group consisting of D-alanine, D-arginine, D-aspargine, D-aspartic acid, D-carnitine, acetyl-D-carnitine, D-camitine D-tartrate, D-camitine magnesium citrate, D-citrulline, D-cysteine, D-cystine, D-GABA, D-glutamic acid, D-glutamine, D-glutathione peroxidase, D-glycine, D-histidine, D-hydroxyglutamic acid, D-hydroxyproline, D-soleucine, D-leucine, D-norleucine, D-lysine, D-methionine, D-ornithine, D-valine, D-phenylalanine, D-proline, D-serine, D-taurine, D-threonine, D-tryptophan, D-tyrosine, and combinations thereof.

In certain embodiments, the dextrorotary organic compound is a sugar selected from a group consisting of dextrin, dextrose, fructose, galactose, glucose, glycogen, inositol, invert sugar, lactose, levulose, maltose, molasses, sucrose, xylose, and combinations thereof.

In certain embodiments, the organic compound is trans-3,5,4′-trihydroxystilbene, an antioxidant compound found in red wine. The compound is commercially available in resveratrol capsules contain 100 mg Polygonum cuspidatum root. It may also be synthesized by methods known in the art.

In certain embodiments, the composition comprising at least one organic compound is contained in an enclosure that prevents direct contact between said composition and said body part of said subject.

In certain embodiments of the methods of improving a biological effect in a subject, the step of contacting a regularizing device to a component is carried out in the presence of at least one device having an electromagnetic field, including a battery.

In certain embodiments of the methods of improving a biological effect in a subject, the step of contacting said imprinted component with said subject while said subject is administered, via ingestion or via contact to a body part of said subject, a composition comprising at least one organic compound is carried out in the presence of at least one device having an electromagnetic field, including a battery.

In yet other embodiments, the invention is directed to methods of improving a biological effect in a subject, comprising the steps:

contacting a coil device to a component selected from the group consisting of a garment, a linen, a floor covering, or a combination thereof for a period of time sufficient to imprint said component to produce an imprinted component;

removing said coil device from said component prior to said contacting said imprinted component with said subject; and

contacting said imprinted component with said subject;

wherein said coil device comprises at least one metallic, non-energized circuit; and

wherein said biological effect is selected from the group consisting of:
an increase in strength of a muscle;
an increase in the rate of stress potentiation of a subject during a physical activity;
an improvement in stability of said subject during a physical activity;
an improvement in flexibility of said subject during a physical activity; and
an improvement in sleep in said subject.
   In preferred embodiments, the step of contacting coil device to a component is carried out in the presence of at least one device having an electromagnetic field, such as a battery. In certain preferred embodiments, the step of contacting said imprinted component with said subject is carried out in the presence of a device having an electromagnetic field, such as a battery. In yet other preferred embodiments, the device having an electromagnetic field used in the step of contacting the imprinted component with the subject is the same device as the device having an electromagnetic field used in the step of contacting the coil device to the component.

Suitable coil devices include devices containing metal coils, such as aluminum, nickel, silver, copper, or combinations thereof, which are not energized. Commercially-available coil devices include the Q-ray and the Q-link available from the Clarus Products International Corporation.

In certain embodiments, the invention is directed to garments, comprising:

a substrate;

wherein said garment is a shirt, pants, underwear, outerwear, footwear, headwear, swimwear, belt, a glove, a headband, or a wristband;

wherein said garment increases strength or flexibility by at least about 2%, preferably at least about 5%, on average, in a group of at least five subjects, when said garment is worn by said subjects who have reached a maximum value in said strength or said flexibility without wearing said garment. Generally, a subject will reach a maximum after being sufficiently warmed-up by at least two or three strength or flexibility tests. In certain embodiments, the subject will then experience a decrease in strength or flexibility back to the previous value prior to wearing the garment. In certain embodiments, the garment is worn by said subjects in the presence of at least one device having an electromagnetic field, especially wherein said device having an electromagnetic field is a battery.

The present invention is further defined in the following Examples, in which all parts and percentages are by weight, unless otherwise stated. It should be understood that these examples, while indicating preferred embodiments of the invention, are given by way of illustration only. From the above discussion and these examples, one skilled in the art can ascertain the essential characteristics of this invention, and without departing from the spirit and scope thereof, can make various changes and modifications of the invention to adapt it to various usages and conditions.

### EXAMPLES

### Example 1

This example showed how treatment of socks with the method of the invention gave enhanced muscle potentiation without repeated exertions to stress-potentiate the leg muscles. It also showed that this test subject was able to lift 9.45% more weight than stress-potentiation alone made possible.

Control Socks: A pair of black, untreated men's socks (Style No. 16T-2240 Black 60 gram/pair Men's 7 inch Ankle height knitted in Thailand with 88% polyester/10% cotton staples intimately blended Dri-release(R) yarns, and 2% Lycra spandex filament knitted in for stretch.

All sock pairs were removed from individual pair, clear polyethylene envelopes. The control socks were worn as received. The test socks were treated as below.

Test socks were imprinted for 12 hours by pulling them over molded plastic foot models that had the circuit pattern ink jet printed on paper taped to the bottoms and tops of the foot arch. After 12 hours at room temperature (˜70 F) the test socks were removed from the foot models and stored separately from untreated control socks until donned for testing eight days later.

The subject was a 70 year old male test subject with a Guidant cardiac pace-maker surgically embedded, and two battery-operated door keys in pants pockets. The test was conducted on a Cybex Leg Extension machine.

A summary of the test conditions and results for leg extension series with the subject wearing control socks not treated in accordance with the imprinting method of the invention or test socks treated in accordance with the imprinting method of the invention are shown in Table 1 below:

TABLE 1

| | | Rest | |
|---|---|---|---|
| | | period | |
| | Testing | prior to | |
| Day | Round | testing | Description of testing |
| 1 | #1 | — | Short series of successful lifts at 34.2 kg, |
| | | | 36.9 kg, 39.8 kg, and 42.6 kg and |
| | | | unsuccessful lift at 45.5 kg (with untreated |
| | | | socks) |
| 2 | #2 | 24 hours | 18 exertion series with alternating treated |
| | | | and control sock tests |
| 3 | — | — | — |
| 4 | #3 | 48 hours | Maximum lift = 48.3 kg |
| | | | 51.1 kg could not be lifted after three 48.3 |
| | | | kg lifts and three 51.1 kg exertions/attempts |
| 5 | — | — | — |
| 6 | — | — | — |
| 7 | #4 | 72 hours | Maximum lift = 59.7 kg (strength |
| | | | improvement relative to Testing Round #3; |
| | | | longer resting period v. Round #3 (72 |
| | | | hours v. 48 hours) |
| | | | Two failed lifts followed by third |
| | | | successful lift at 45.5 kg and three |
| | | | successful lifts at 48.3 kg; |
| | | | Seventh exertion at 51.1 kg failed but |
| | | | eighth exertion succeeded; |
| | | | Ninth and tenth exertions/attempts were |
| | | | successful at 54 kg, but eleventh |
| | | | exertion/attempt at 56.8 kg was not |
| | | | successful |
| | | | Test subject rested for 5 minutes and then |
| | | | the twelfth exertion/attempt at 56.8 kg was |
| | | | successful; |
| | | | Thirteenth exertion/attempt at 59.7 kg was |
| | | | successful; |
| | | | Fourteenth and fifteenth exertions/attempts |
| | | | at 62.5 kg were not successful. |
| 8 | #5 | 22 hours | Since the previous days control sock test |
| | | | had failed twice at 8 weights (45.5 kg), and |
| | | | had not potentiated to 9 weights (51.1 kg) |
| | | | until the eighth exertion, it was decided to |
| | | | start the aided tests at 9 weights. This was |
| | | | also +12.5% above the start, which is about |
| | | | the percent improvement observed with |
| | | | treated over untreated socks in a number of |
| | | | earlier tests. |
| | | | Surprisingly, the test subject lifted the 51.1 |
| | | | kg weight in the first attempt, and again in |
| | | | a second attempt. It was decided to skip |
| | | | repeat weight lifts after that, and increase |
| | | | the weight by 2.84 kg in each succeeding |
| | | | lift until one failed. Initial lifts at 9.5, 10, |
| | | | 10.5, 11, and 11.5 weights (65.3 kg) all |
| | | | succeeded. The first lift failed at 12 |
| | | | weights (68.2 kg). at the eighth exertion. A |
| | | | second try at 11.5 weights succeeded, but a |
| | | | second try at 12 weights did not. It was |
| | | | concluded that 65.3 kg was the maximum |
| | | | possible. This was +9.5% above the |
| | | | maximum achieved in the control socks at |
| | | | the thirteenth unaided exertion on the |
| | | | previous day (Day 7). |
| | | | To confirm an unaided maximum after the |
| | | | 63.5 kg aided one, the test socks and shoe |
| | | | insoles were removed, so there was no |
| | | | chance of an imprinted surface in contact |
| | | | with the bare feet. The next lifts at 11 |
| | | | weights and then at 10 weights (56.8 kg) |
| | | | both failed. It was not until 9 weights (51.1 |
| | | | kg) was tried again that the weights could |
| | | | be lifted. Two attempts at 9.5 weights (54 |
| | | | kg) then failed as the 13th and 14th |
| | | | exertions. It appears that some muscle |
| | | | fatigue was occurring that reduced the |
| | | | maximum unaided lift strength from the |
| | | | 10.5 weight maximum of the 13th lift on |
| | | | the previous day. Thus, the unaided |
| | | | maximum after removing treated socks |
| | | | was −14.4% below the unaided maximum by |
| | | | stress exertion only on the previous day |
| | | | (Day 7). |

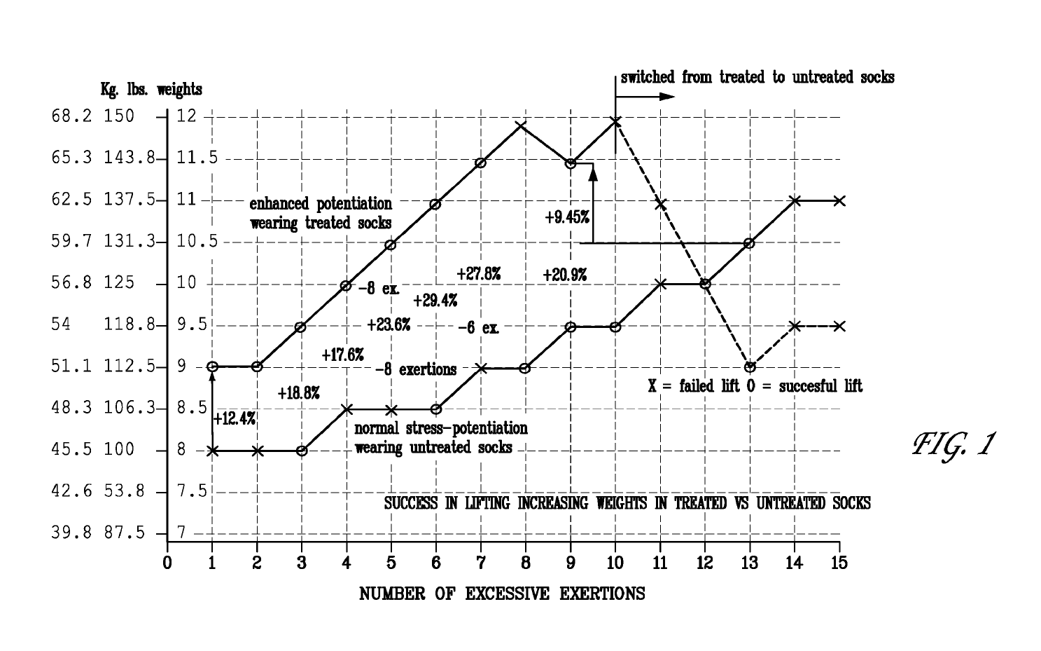

FIG. 1 displays graphically the potentiation in leg extension strength by the treated socks eight days after their treatment, compared to the best stress-potentiated strength possible on the preceding day wearing the same type socks untreated.

Unexpectedly, wearing socks treated in accordance with the imprinting method of the invention permits:
(1) an immediate lift strength +12.5% above that which took two stress potentiations to reach unaided;
(2) no failed lifts up to the 65.3 kg aided maximum in the seven exertion, compared to six failures while stress-potentiating unaided to reach the 59.7 kg maximum in the thirteenth exertion, or 46% as many exertions to achieve a 9.5% higher maximum in the treated socks;
(3) only one-third the exertions to reach intermediate strength levels (54 kg and 56.8 kg), and 38.5% as many to reach the maximum strength achieved unaided of 59.7 kg.
   The treated socks accelerate and enhance muscle potentiation so as to make repeated maximal stress exertions to achieve maximum strength unnecessary.

### Example 2

It was demonstrated that repeated maximal exertions in a leg extension test, prior to testing socks, could increase the average force exerted in a maximum isometric knee extension. The force measured in the first trials with untreated socks increased 5.5% in a second test. With treated socks, the third test was 5.5% higher, and the fourth was another 4% higher. Two weeks later, after the muscles had been fully potentiated by multiple maximal exertions another 4.4%, there was no significant further increase over seven trials with or without the treated socks. Therefore, multiple extreme exertions can push muscles to their maximum, and that the method of the invention increases potentiation below the maximum without requiring such extreme maximal exertions or electrical stimulation.

### Determination of Leg Extension Muscle Potentiation by Maximal Exertion

On Day 1, the same test subject who tested hand grip and leg extension potentiation, with socks treated to enhance potentiation, but with minimum maximal strength exertions, tested the effect of only using maximal strength exertions to cause potentiation.

The tests were started at the 45.5 kg (8 weights) level that was the most lifted after first lifting 34.1 kg and 39.8 kg stacks of 6 and 7 weights in the control socks at the start of the previous tests. The subject could not lift the 45.5 kg weights during the first two maximal exertions. However, the third exertion lifted the eight weights, just as in the previous test. This confirmed that leg muscle potentiation occurred sufficiently after two exertions to permit eight weights to be lifted. Then the eight weights were lifted two more times. After two unsuccessful tries, and three successful lifts at 45.5 kg, 48.3 kg could be lifted in a sixth attempt. The 8.5 weights were lifted two more times, then 51.1 kg (9 weights) were tried, but could not be lifted in three maximal effort tries. Therefore, it was concluded that the maximum strength lift possible for the test subject by maximal exertion only was 48.3 kg, without the aid of treated socks.

In the previous day's tests, 51.1 kg was lifted in the fifth exertion with treated socks (+12.3%) versus 45.5 kg in the fifth exertion with control socks above. The 51.1 kg could not be lifted in control socks in the fourth or ninth exertions in the first day's trials. The 51.1 kg weight could not be lifted in ninth, tenth, or eleventh exertions in the control socks on the second day, so potentiation to the higher 51.1 kg level did not appear possible in control socks.

Maximum potentiation occurred in the seventeenth exertion to 54 kg in the treated socks in the first trial (+11.8%), versus the maximum 48.3 kg in the sixth, seventh, and eighth exertions in the control socks on the second day. The 48.3 kg level was not tried in the control socks on the first day. The maximum lifts in the control socks on the first day were at the third and thirteenth exertions to 45.5 kg. The fifth, eighth, and sixteenth exertions in the treated socks were 12.3% higher (51.1 kg) than the control sock maximum on the first day, and the 54 kg treated sock maximum was +18.75% higher than the 45.5 kg tested maximum in control socks on the first day.

Therefore, the treated socks cause maximum potentiation to be 12+/−0.3% higher from the fifth to the seventeenth exertions than in control socks, as much as 18.75% higher than the maximum in untreated socks on a given day.

### Example 3

It was demonstrated that repeated maximal exertions in a leg extension test, prior to testing socks, increased the average force exerted in a maximum isometric knee extension to 331.4 N-m. The force measured in the first trials with untreated socks began at 274 N-m and increased to 289 N-m in a second test. With treated socks, the first test was 305 N-m and the second was 317 N-m. Two weeks later, after the muscles had been fully potentiated by multiple maximal exertions to the 331.4 N-m maximum, there was no significant increase wearing the treated socks. Therefore, the imprinting treatment of the invention increases potentiation below the maximum without requiring the prior maximal exertions or electrical stimulation.

### Hand Grip Dynamometer Tests

A new pair of the same type socks above was treated 12 hours (overnight) and then tested for their effect on dominant hand grip strength 12 hours later. Maximal grip was exerted in each test, such that potentiation should occur in 4-5.5% steps to a maximum as above. A Lafayette Instrument Hand Dynamometer Model 78010 was used in right hand tests.

Repeated tests did not show any significant potentiation between first and second maximum hand grip squeezes due to exertion only. The first unpotentiated strength with bare feet was 31.8 kg. The second test with the treated socks gave 35.5 kg or 11.6% stronger grip. This was even two times higher that seen in leg extension potentiation effects due to maximal exertion only. Thus, enhanced potentiation was due to the sock treatment. A third maximum squeeze in bare feet gave 11.5% reduced strength, back to 31.4 kg, or 1.25% less than the first bare feet testing result. A fourth squeeze in control socks gave only 1.4% higher grip back to the initial 31.8 kg. Placing magnets over the lower right arm muscles gave no change in grip in a fifth maximum exertion. One of the treated socks was inserted under the magnet belt and gave a 5.7% strength increase. Removing the belt and sock gave a 13.4% lower grip strength to 29.1 kg in a seventh grip. There was 2.7% fatigue loss from the first bare foot test, or 0.45% per grip. Re-donning the treated socks gave a 12.4% increase to 32.7 kg in the eighth grip. With the treated (imprinted) socks plus the regularizing device used to initially imprint the socks, against the arm muscles at the elbow, it gave a further 11.3% grip increase to the maximum achieved of 36.4 kg. Removing the device over the arm muscle reduced the tenth grip 7.7%, with the treated socks only, to 33.6 kg. A final eleventh squeeze back in bare feet gave a cumulative fatigue loss of 11.3% to 28.2 kg, or ˜1% loss per exertion. All of the potentiation effects were clearly due to the treated socks or regularizing devices. There was no evidence of potentiation due to exertion only. Fatigue losses seemed very consistent and as expected over the eleven maximal exertions.

### Cybex Leg Extension Test Series

Twelve hours after the above, or 24 hours total after treatment, a leg extension series was carried out in a similar way to the above hand grip tests. Testing was on a Cybex exercise unit. Potentiation due to exertion could have occurred as the test subject lifted increasing weights to find his maximum limit, but could not be measured. The subject lifted 34.1 kg, then 39.8 kg and 45.5 kg weights with increasing difficulty. Nine weights of 51.1 kg total could not be lifted in the 4^{th} exertion with the control socks. After changing to the treated socks, nine weights could be lifted in the fifth exertion, but 10 weights (56.8 kg) could not be lifted in a sixth exertion. A seventh test with 9.5 weights or 54 kg could not be lifted either, and only 51.1 kg could be lifted in the eighth exertion, as in the fifth test with nine weights in the treated socks. Thus, the treated socks enhanced potentiation such that 12.5% more weight could be lifted than when wearing the untreated control socks (UCS).

The subject changed back to the UCS for the ninth exertion, but could not lift the nine weights, nor even eight weights (45.5 kg) in the tenth exertion. This indicated some fatigue since eight weights had been lifted wearing the control socks in the third exertion. Seven weights (39.8 kg) could be lifted in the eleventh exertion. Then 7.5 weights (42.6 kg) could be lifted in the twelfth maximum exertion. Eight weights (45.5 kg) were then lifted in the thirteenth maximum exertion, so some potentiation may have occurred due to the increasing weight lifted from the eleventh to the thirteenth exertion. However, 8.5 weights (48.3 kg) could not be lifted in the fourteenth exertion, until after the socks were changed back to the treated pair for the fifteenth exertion. The subject lifted 9 weights (51.1 kg) in the sixteenth exertion, as in test 5, and then was able to lift 9.5 weights (54 kg) in the highest yet seventeenth exertion for an 18.75% strength increase over the best lift wearing untreated socks. This may indicate some exertion potentiation, since the subject had not lifted 54 kg in the seventh test with the treated socks. A final eighteenth effort at 56.8 kg did not succeed. The test subject was a 70 year old male with a Guidant Model H219 CRT-D cardiac implanted pacemaker, and two battery-operated car keys in his pockets.

### Example 4

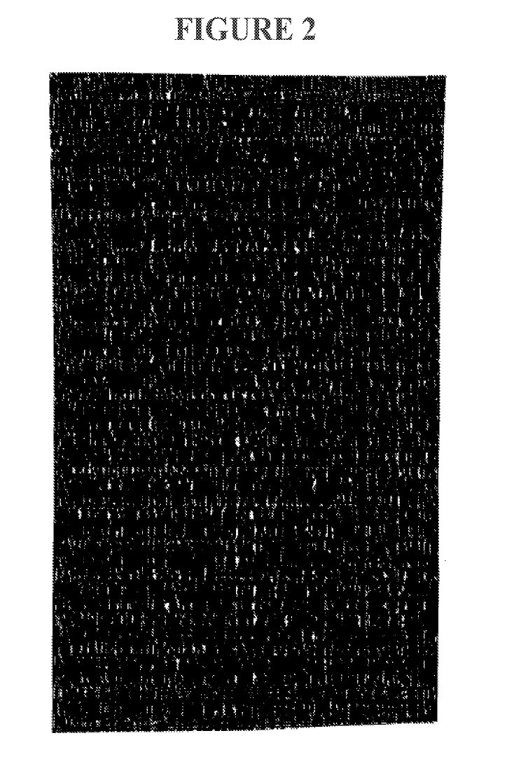

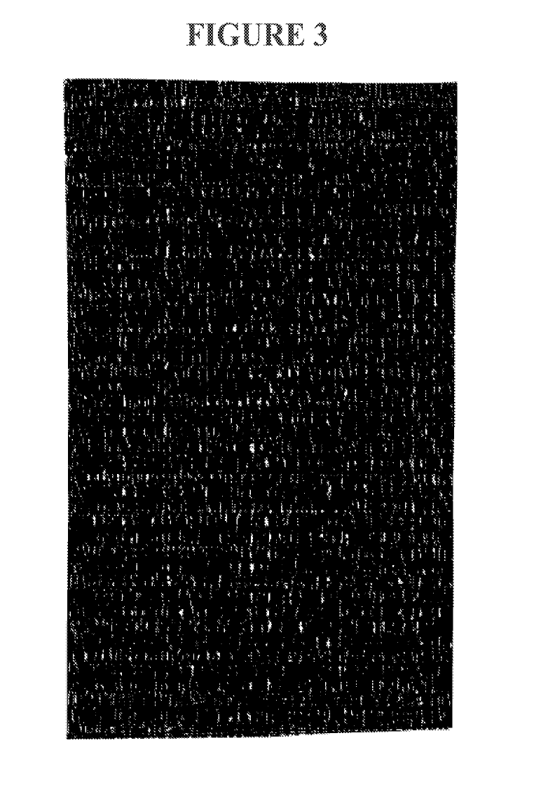

FIGS. 2 (original pattern) and 3 (pattern after scanning of FIG. 2 and reprinting) show regularizing devices that have been used to imprint various components. The copy of this scanned image was made on a Xerox desktop DocuPrint P8ex ink jet printer and gave a +27.3% increased hand strength (34 kg versus 25 kg for control) simply by standing barefoot on the area shown versus standing directly on carpet. The pattern was made originally on the same printer, so it was printed, scanned, and re-printed. Surprisingly, it appeared to become more effective after each step, rather than less so.

Hand grip strength on untreated carpet versus on each of five different prints from the same printer was tested. The pattern shown in FIG. 2 prior to scanning gave an average +17.1% increased strength. It was a copy of the original made on the same printer. That original gave +10.2% increased strength, and was second in absolute effect to its copy (32 kg versus 32.7 kg average of two tests each). The bare pattern gave an average of only 30 kg grip strength, although it was +12.8% better than the carpet tests just before and after the pattern test, but only fourth best in the series. The third best was the pattern with only one overprint.

Leg extension test were conducted with

(1) control untreated socks;
(2) a pair imprinted on the best example above; and
(3) a pair imprinted on the simple pattern that was ranked fourth above.
The control series gave a similar result of taking three exertions at 8 weights (45.45 kg) before the subject successfully lifted that weight. The pair imprinted with the best example above, that was used to make the pattern in FIG. 2, permitted the subject to lift increasing weights in 2.84 kg increments all the way to 59.7 kg, (near subject's previous best). The subject could not lift 62.5 kg in two more exertions. The socks imprinted by the original pattern did not permit the 62.5 kg lift in two more tries, and did not permit the 59.7 kg lift of the best example above in two more tries. Finally, the subject was able to lift 56.8 kg with these socks, but not 59.7 kg in one more try at the end of the series. Therefore, this example gave a +31.4% increased maximum strength over the untreated control, and a 5.1% increased strength over the original simple pattern.

The other important result was that multiply overprinted versions, copied and scanned and recopied do imprint socks in an overnight exposure to give the best result of the examples tested.

### Example 5

A 100% cotton pillowcase was treated for 2 hours with two side-by-side panels of the regularizing devices in the central area of one side. The outer corners of the treated area were marked with safety pins so the test subject could easily determine the treated zone for head placement.

The test subject was a 70 year old, light-sleeping male who wakes every 2-3 hours as his usual sleep pattern. The subject takes one 25 mg Melatonin before retiring, and one after waking later. Even so, the subject often has difficulty relaxing to get to sleep.

On the first-night test, the subject went to sleep quickly on the treated pillow-case. After waking about 2.5 hours later, the subject took another Melatonin and resumed laying his head on the treated area. Instead of going back to sleep quickly, the subject's mind was more active with thoughts and ideas than usual. Several significant new ideas about his recent problems occurred. After several hours, the subject decided to try using the other, untreated side of the pillow to see if the treated side was keeping his mind overactive.

The subject went back to sleep and, in fact overslept by 30 minutes his usual time of awakening. The next night the test was repeated, with quick initial sleep on the treated pillow side. The treated pillow was not used after the first awakening, and the subject went quickly back to sleep without the over-active thinking experienced the first night when laying back on the treated side.

### Example 6

A Land's End 85/15 polyester/cotton T-shirt was treated overnight by placing a 16 cm by 23 cm sheet of the regularizing devices (each having at least one non-metallic, non-conductive or semi-conductive, non-magnetic, and non-energized circuit) so that it was centered in contact with the neck and shoulder area of the inside of the medium size men's shirt. This was the same area of the same devices previously placed in contact with the upper shoulder and chest by gluing them to the surface of a hangar for test on Day 1. It was noted that the shirt was not in contact with two imprinted areas of 8 cm by 6 cm in the neck cut-out of the shirt, and there was no contact in the central upper back area that fell below the hangar arms. The large shoulder muscles extend into those areas not contacted, therefore this test was set up to check whether imprinting the central shoulder muscle area of the shirt more completely would make any difference in strength effect.

The same test subject used on Day 1 was slightly weaker (81.25 versus 87.5 pounds) in the chest lift test, in a similar shirt to the test shirt with no imprinting treatment. This is likely due to the addition of an iPhone in the left pocket to two car openers in the right pocket. The strength increases in the sheet-treated test shirt were larger (+30.8% versus +14.3%), such that the maximum strengths were exactly the same for both test days. The test subject was able to lift the same maximum 106.25 pounds lift with the complete sheet contact imprint that could only be lifted on Day 1 with the lesser area hangar imprint, plus the hangar itself inserted in contact with the upper back muscles at the same time. A more complete imprint on the shirt's central back, over the shoulder muscles, increased the effect of the imprinted shirt, and make the use of the hangar unnecessary.

The energy maximum in watts was also lower on Day 2 both without and with the imprinted test shirt (−14.5% and −17.4%). The 10 second anaerobic energy test was done with both legs and arms on the Schwinn bicycle in both cases. The increase in watts output was only +4% with the imprinted shirt. Therefore, a second anaerobic test was done using arms only, since the imprint was only done on the upper shoulder muscle area of the shirt. With arms only, the imprint shirt gave a +22.5% increase in watts output versus the control shirt (174 W versus 142 W). This indicates again that the effect is specific to the muscles adjacent to the imprint and that are primarily used in the strength test.

In the afternoon of Day 2, the Lafayette Hand Dynamometer test gave 60 pounds maximum right hand grip again with a control shirt without imprinting. The maximum right hand grip wearing the test shirt imprinted only on the middle upper back gave no improvement, so the hangar imprint that went all the way out and over the tip of the shoulder was better for increasing hand grip strength than when the same imprint area, pattern and exposure time was only in the middle of the back of the shirt. The hand grip test uses primarily the lower and upper arm muscles. Therefore, the back-imprinted shirt was then removed and the imprinted area held on the upper right arm muscle, and then on the lower right arm muscle.

In both cases, the maximum right hand grip strength was increased to 68 pounds, or +13.3% versus the control strength of 60 pounds. The only known difference in the test conditions between Day 1 and Day 2 was that an iPhone was also in the pocket of the test subject in addition to two electronic car door openers of the Day 1 tests.

With the iPhone present (in addition to the two electronic car door openers) there was no improvement from moving the imprint area into contact with the upper arm, and only from 60 to 62 pounds by contacting the lower arm muscle. When the iPhone was removed, the imprinted area of the shirt on the upper arm muscle allowed a 64 pound grip. Adding the hangar in contact with the lower arm muscle allowed a maximum of 66 pound grip. Without the iPhone in the previous day's test, the same condition permitted a 74 pound maximum grip. The iPhone EMF field seemed to be particularly detrimental to strength correction.

### Example 7

A Jones of New York plastic hangar made by Continental Hangar was covered on the upper surface, shaped to simulate the shoulder muscles, with regularizing devices of the invention. The crossbar between the shoulder tips also had a ⅜ inches by 15 inches layer of regularizing devices of the invention bonded so that the breast muscle area under the shirt would be treated. The shoulder tips were 1¾ inches wide and the hangar width near the neck was 1 inch wide. The devices were overprinted by three 5 mm offset QWERTY patterns.

A chest press machine was set at a 3 seat height, and the maximum lift weight was 7×12.5=87.5 pounds when the test subject wore a control shirt (without any imprinting from the regularizing devices of the invention). The 8×12.5=100 pound weights could not be lifted.

Then the Land's End Dri-release® T-shirt was taken off the imprinting hangar of the invention where it had hung from 11 PM Monday to 8 AM Tuesday (Day 1). The 70 year old male test subject wearing a Guidant heart pacemaker and two electronic car door openers in his pants pockets, then donned the imprinted medium T-shirt, and was able to lift 8×12.5=100 pounds of weights, but not 8.5×12.5=106.25 pounds. This was a 14.3% increase in lift strength.

The hangar was then held against upper back center muscle while still wearing the shoulder-chest imprinted shirt. Then 8.5×12.5=106.25 pounds of weights was lifted for a 21.4% shoulder strength increase with both imprinted shirt and hangar in contact with the key muscles.

The control Land's End T-shirt was then worn during a 10 second maximum bicycle effort that gave 379 watts maximum output. Wearing the imprinted T-shirt, the test subject was able to increase his 10 second output 7.7% to 408 watts. Only the upper body muscles had the imprint contact, while the leg muscles did much of the effort.

In the afternoon of Day 1, the Lafayette Hand Dynamometer test gave 60 pounds maximum right hand grip (control T-shirt without imprinting) versus 70 pounds (wearing the imprinted T-shirt above) for +16.7% increased hand strength. Holding the hangar against the lower arm muscle while wearing the imprinted shirt gave 74 pounds maximum, or +23.3% increases.

Without the imprinted shirt, holding the hangar against the right upper arm muscle gave 63 pound maximum grip, or only +5% increase. Holding the treated hangar against the lower right arm muscle gave 70 pounds, or the same +16.7% increased grip strength achieved with the imprinted T-shirt only.

### Example 8

The imprinting of the components has a time duration of at least 100 days. A blue Land's End shirt was imprinted for nine hours from 11 PM April 7 to 8 AM Day 1 on a plastic hangar covered with a regularizing device. The Hand Dynamometer test on July 28 at 2:30 PM (112 days or 16 weeks or 4 months) since the test shirt was imprinted. The shirts were washed after testing and then stored separately in a closet.

The control shirt was a blue Land's End shirt of the same style that was not imprinted. It gave a 55 pound grip in a first exertion now versus 60 pound grip in the first exertion recorded on Day 1. The subject was not aware of the stress potentiation effect back then, so the subject may have done some exertions before that test then. The subject did a second exertion today that gave 58 pounds, so a small stress potentiation effect to nearly the same result as then.

The subject then tested the blue medium Land's End T-shirt that had been imprinted for 9 hours (4 months earlier). The subject got the exact same 70 pound result 4 month's later. Therefore, the subject got the same 16.7% increased strength from the imprinted shirt versus the control shirt then, and 27% and 20.7% versus this example's two exertions in the control shirt. The subject did a second exertion in the imprinted shirt that gave 66 pound grip. This was the fourth total exertion when some muscle fatigue began, but that still gives 20% to 13.8% higher grip strength than the two control tests.

### Example 9

In this example, different substrates were tested to determine if they could be imprinted by the regularizing devices of the invention.

### Testing of Polyester/Cotton Blend Fabric

A polyester/cotton blend T-shirt was imprinted with a regularizing device in the presence and absence of a small direct current (DC) battery (1.5 V). The subject then dressed in the imprinted T-shirt and tested his right hand grip strength with a Lafayette Hand Dynamometer Model 78010. After each set, the T-shirt was removed and again imprinted with the regularizing device in the presence or absence of the DC battery for a set period of time. Then, the subject then dressed in the imprinted T-shirt and repeated the strength test for a period of over one hour. The results are shown below:

| Without Battery on Fabric | | | With Battery on Fabric | | |
|---|---|---|---|---|---|
| during Imprinting | | | during Imprinting | | |
| Elapsed | Imprint Times | Maximum Weight | Elapsed | Imprint Times | Maximum Weight |
| Time | between Tests | Lifted during | Time | between Tests | Lifted during |
| (minutes) | (minutes | Set (pounds) | (minutes) | (minutes) | Set (pounds) |
| 0 | 8 | 65 | 0 | 8 | 65 |
| | | (prior to | | | (prior to |
| | | imprinting) | | | imprinting) |
| 10 | 5 | 70 | 11 | 5 | 78 |
| 20 | 5 | 73 | 17 | 5 | 84 |
| 26 | 5 | 77 | 27 | 5 | 85 |
| 38 | 5 | 74 | 37 | 5 | 88 |
| 45 | 5 | 79 | 48 | 5 | 88 |
| 57 | 5 | 76, 74* | 56 | 5 | 79 |
| 65 | 5 | 67, 72* | 63 | 5 | 76, 73* |
| 72 | 5 | 65, 74* | 71 | 5 | 64, 60* |

*Repeated testing with an iPhone and Honda and Audi car openers in tester's pockets.

This testing shows that the presence of the battery significantly increased the strength enhancing effect of the regularizing device, when the battery is present during the imprinting step. The fall off in strength is theorized to be due to muscle fatigue and may be caused by a depletion of cell ATP (chemical energy). Accordingly, the most increased series (i.e., the series where the imprinting was done in the presence of the battery) falls off the fastest, while the less enhanced series (i.e., the series where the imprinting was done in the absence of the battery) still has ATP left to energize.

### Testing of Paper (Wood Pulp Product)

On Day 1, the test subject, stood barefoot on a sheet of Staples 92 Bright, 20 pounds, 8.5 inch×11 inch computer paper, Item 135855 taken from the center of a 500 sheet pack. The test subject got an unusually high first control grip of 72 pounds. in both a first and second grip with a Lafayette Hand Dynamometer. The sheet of paper was then exposed to a one minute exposure to a regularizing device of the invention (printed with non-metallic, non-conductive or semi-conductive, non-magnetic, and non-energized circuit) and the test subject got 72 pounds again, while standing barefoot on the imprinted paper. After an added 5 minute exposure, the test subject got 72 pounds again. After an added 10 minute exposure, the test subject got 76 pounds at which time he realized he had not indexed the repositioning of the pattern carefully, so the 10 minute exposure might not be cumulative with the first 1 and 5 minutes. The test subject restarted the test. All of the preceding imprinting and testing was done without any EMF devices (for example, DC batteries from cell phones or electronic car door openers). When the control test was redone, the test subject got a reduction from 72 pounds to his usual 66 pounds with an iPhone and two electronic door key openers in pockets.

On the unused half of the above sheet, the test subject began again using a regularizing device of the invention (printed with non-metallic, non-conductive or semi-conductive, non-magnetic, and non-energized circuit), and got 72 pounds after 1 minute exposure. The two tests indicate that one minute is not sufficient to imprint paper. The test subject had indexed the position of the two papers in this test, so he gave it another 15 minute exposure on the same location (within about 1/32 inch}. After a total of 1+15 minutes imprinting with regularizing device, the test subject got a 76 pound grip, when standing on the imprinted paper barefooted. The test subject got 76 pounds after 21 minutes, and two tries at 31 minutes, while standing on the imprinted paper barefooted. After 25 more minutes to 56 minutes total imprinting with regularizing device, the test subject got a 78 pound grip. This same grip level was measured after 91 and 120 minutes of imprinting with regularizing device, when the hand grip test was conducted in bare feet. With a sock on, the test subject got 76 pounds for the eighth reading, before the final test.

The next morning, the test subject stood barefoot again on a plain sheet and got the more usual control value of 66 pounds grip. He then stood on the imprinted part of the sheet imprinted the prior day and got 70 pounds grip. The test subject then taped the same sheet around his right arm muscle just below the elbow and got a reading of 86 pounds. These tests indicate that wood pulp paper can be imprinted to give 6 to 8% increased grip strength when contacted with the skin of the foot, and 30% increase if the same imprinted component is positioned on the arm muscle being stressed.

The test subject took a fresh sheet of paper as above and began imprinting with a regularizing device of the invention (printed with non-metallic, non-conductive or semi-conductive, non-magnetic, and non-energized circuit). The test subject did a control grip on untreated paper and got a 73 pound grip (without batteries). His earlier tests had partially potentiated his right arm muscle. After 5 minutes of imprinting of the sheet with the regularizing device in the presence of an iPhone and two electronic car door openers, the test subject had a 78 pound grip when the sheet was taped around the right arm (+6.85%) (without the iPhone and two electronic car door openers on the test subject). After 5 more minutes or 10 minutes total imprinting of the same sheet with the regularizing device in the presence of an iPhone and two electronic car door openers, the test subject got 82 pounds grip (+12.3%) (without the iPhone and two electronic car door openers on the test subject). After another 5 minutes (15 minutes total) in the presence of an iPhone and two electronic car door openers, the test subject got 80 pounds (without the iPhone and two electronic car door openers on the test subject). After another 5 minutes imprint to a 20 minute total in the presence of an iPhone and two electronic car door openers, the test subject got 76 pounds (without the iPhone and two electronic car door openers on the test subject). The testing with the imprinted sheet was repeated in the presence of an iPhone and two electronic car door openers and the test subject got a 84 pound grip, or 15% increase above control in the absence of an iPhone and two electronic car door openers, and 27.3% above the control in the presence of an iPhone and two electronic car door openers (66 pounds). These results indicate that the EMF sources (the batteries in the iPhone and two electronic car door openers) on one's person reduce strength (when the test subject is not contacting an imprinted component of the invention), and that the EMF sources on one's person improve strength more if the EMF sources are on your person than if they are not (when the test subject is contacting an imprinted component of the invention.

| | Imprinting Step | | Testing Step | |
|---|---|---|---|---|
| | (use regularizing device | | (contact imprinted | |
| | to imprint component) | | component to test subject) | |
| | Control | Invention | Control | Invention |
| Description | Not | EMF device | EMF device | EMF device |
| | Applicable | increases | decreases | increases |
| | | strength during | strength v. w/o | strength v. w/o |
| | | testing step v. | EMF device | EMF device |
| | | w/o EMF device | | |
| | | EMF device | | |
| | | increases strength | | |
| | | the most when the | | |
| | | same device used in | | |
| | | imprinting step is | | |
| | | worn on the test subject | | |
| | | during testing step. | | |
| | | Materials imprinted | | |
| | | without an EMF device | | |
| | | during imprinting step | | |
| | | still increase strength | | |
| | | during testing step for | | |
| | | test subject not | | |
| | | wearing EMF device, | | |
| | | but to lesser extent | | |
| | | than the test subject | | |
| | | wearing EMF device. | | |

This indicates that the weak EMF fields emitted by the cell phone and electronic car door openers are powering the passive imprinted patterns to help increase strength to higher levels when the imprinted component is present, and further reduce strength when the imprinted component is not on the test subject, but the EMF devices are present during the testing.

After 5 more minutes to 25 minutes total, the test subject tested his control strength with an iPhone and electronic car door openers in his pocket, and got 66 pounds grip. Without the iPhone and electronic car door openers in his pocket, the test subject was stress-potentiated up to 76 pounds grip, and had 81 pounds grip with the minutes imprinted component (paper) around my lower right arm.

In the previous day's tests, the test subject had seen a second increase after less than an hour's imprinting of the paper. It is believed that wood and paper are heterogeneous mixtures of materials with at least two different electron structures. If the imprint energy is affecting electron spins or alignments, then the test subject should see the same effect between the previous day's test and this test. To test this hypothesis, the test subject imprinted the paper for another 30 minutes (55 minutes total) and tested all of the possible combinations shown in the table below.

| | EMF | | Hand | |
|---|---|---|---|---|
| | devices | Imprinted | grip | |
| | in pocket | component | measure- | |
| | during | during | ment | |
| | testing | testing | (pounds) | Comments |
| Test 1 | Yes | No | 62 | Presence of EMF |
| (control) | | | | devices reduces |
| Test 2 | No | No | 66 | grip by 6% (Test |
| (control) | | | | 1 v. Test 2) |
| Test 3 | Yes | Yes | 81 | Imprinted |
| | | | | component |
| | | | | improves grip by |
| | | | | 22.7% (v. Test 2) |
| | | | | and by 30.6%? (v. |
| | | | | Test 1) |
| Test 4 | Yes | Yes | 85 | Imprinted |
| | | (on arm | | component |
| | | muscle) | | improves grip by |
| | | | | 28.8% (v. Test 2) |
| | | | | and by 37%? (v. |
| | | | | Test 1) |

The maximum grip was increased by about 5% relative to testing after 25 minutes. Thus, this testing day's more careful test supports that some second phase is potentiated between 25 and 55 minutes imprinting, as in the previous day's tests with the weaker method of standing on the imprint that did give 2.6% further increase in the same time period.

### Example 10

In this example, insoles were subjected to imprinting cycles and tested by the subject for effect on performance. More specifically, Dr. Scholl's air foam shoe insoles were tested to determine whether they could be imprinted in less than a three hour imprinting cycle to provide a durable performance enhancement function. Also, the effect of an alternating EMF device on the imprinting time was also tested.

The grip strength of a 70 year old male test subject was studied. Hand grip strength was about 60 to 62 pounds (control with statin drug treatment) over the previous year while the test subject was taking 20 mg Simvastatin statin drug daily. After the test subject was no longer using the statin drug, the test subject had a hand grip strength of about 65 to 68 pounds (control with no statins).

The imprinting cycle time and other factors for treatment of insoles in accordance with the invention were then determined:
A. A two-week hiatus in daily 20 mg statin correlates with an about 13% increase in control grip strength (from 60 to 68 pounds). An increase in maximum grip from 80 to 88 pounds also occurred. The statin was then re-started to see if weakening back to the previous level occurs over a similar time period.
B. Imprinting in the presence of a battery for 5 minutes gave 95% of previous 3 hour cycle (76 pounds v. 80 pounds). Another 32 minutes gave about the same 10-13% increase to maximum of 88 pounds previously achieved with 3 hour treatments during the statin hiatus.
C. The imprinting effect was transferred from treated insole to socks worn in test series in about the same total exposure time (5 minutes) as above.

### Experimental Details

A five minute imprint with the regularizing device having at least one non-metallic, non-conductive or semi-conductive, non-magnetic, and non-energized circuit with one electronic car door opener present gave a 75 to 78 pounds (+25 to 30%) maximum grip with electronic car door openers in test subject's pockets. This was only about 2.5 to 5% less than the usual 80 pound grip of 3 hour imprints.

Due to the chemical effects of a) taking Seidman's Anti-aging/Strength capsules or b) not taking a statin, further imprinting for 32 minutes with the electronic car door opener with battery was carried out to see if any greater increase of grip strength occurred. The control insole gave non-statin 68 pounds without battery and 65 pounds with battery. The imprinted insole gave 80 pounds with battery and 70 pounds without battery. These treatments are equal to 3 hour battery-treated soles before statin was stopped, so the 5 minutes treated effect is not changed, as with the control.

Bare feet on the imprinted insole (where the test was carried out in the absence of a battery) gave an increase from 70 pounds to 78 pounds, which is typical because the imprinted component (the insole) is closer to skin. Bare feet on the imprinted insole (where the test was carried out in the presence of a battery) increased to 86 pounds, suggesting that the skin is at least temporarily treated, and enhanced by the absence of the battery (or EMF-drivable) also.

The following day, the control insole gave 65 pounds with socks (wherein the test was carried out in the presence of an iPhone and two electronic car door openers), and the imprinted test insole gave 70 pounds (wherein the test was carried out in the absence of an iPhone and two electronic car door openers. Without batteries (from keys or iPhone device) the control gave 77 pounds, thus indicating that either the socks, or control insole, or both had been imprinted during the previous day's testing, so that the EMF devices or EMF-imprinted insoles depress grip and are not energized from control.

Then a series of tests was done on the imprinted test insole a) with two electronic car door openers only (82 pounds) b) with an iPhone (in off position) and two electronic car door openers off (85 pounds), and c) with an iPhone (in on position) and two electronic car door openers (88 pounds). This indicates that the imprinted battery-treated insoles are increasingly energized by higher EMFs. Without two electronic car door openers, but with iPhone on, the imprinted gave 80 pounds and the control gave 75 pounds. With an iPhone (in on position) and two electronic car door openers, the control insoles gave 71 pounds with socks and 75 pounds without socks, again consistent with distance from skin.

It is theorized that the increase to 88 pounds maximum is due to the dissipation of the statin effect, since the test subject did not get any increases over his former 80 pounds maximum even when between taking Seidman's Anti-aging/Strength capsules, before he stopped the statin.

The data collected in this example is summarized in the table below.

| | Imprinting | | | | | | |
|---|---|---|---|---|---|---|---|
| | Time on | EMF Device | | Handgrip | | Socks | |
| | Insole | During | During | Measurement | Statin | v. Bare | |
| Test | (minutes) | imprint | Testing | (pounds) | Treatment | feet | Comments |
| Control 1 | — | No (no | Yes | Average of 60-62 | 20 mg daily | Socks | |
| | | imprinting) | (auto key | (over last year) | | worn | |
| | | | battery) | | | | |
| Control 2 | — | No (no | Yes | 65-68 | Off statins | Socks | 13% increase |
| | | imprinting) | (auto key | | for 2 weeks | worn | relative to |
| | | | battery) | | | | Control 1 with |
| | | | | | | | statins |
| Example A | 360 | No | Yes | Average of 80 | Off statins | Socks | |
| | | | (auto key | (over last year) | for 2 weeks | worn | |
| | | | battery) | | | | |
| Example B | 5 | Yes | Yes | 75-78 | Off statins | Socks | 2-5% less than |
| | | (auto key | (auto key | Average 76 | for 2 weeks | worn | Example A |
| | | battery) | battery) | | | | (with 360 |
| | | | | | | | minute |
| | | | | | | | imprint); +25- |
| | | | | | | | 30% with |
| | | | | | | | battery during |
| | | | | | | | imprint v. |
| | | | | | | | Control 1 |
| Control 3 | — | No (no | Yes | 65 | Off statins | Socks | Presence of |
| | | imprinting) | (auto key | | for 2 weeks | worn | battery during |
| | | | battery) | | | | testing without |
| | | | | | | | imprinted |
| | | | | | | | pattern causes |
| | | | | | | | decrease |
| | | | | | | | relative to |
| | | | | | | | Control 4 |
| Control 4 | — | No (no | No | 68 | Off statins | Socks | |
| | | imprinting) | | | for 2 weeks | worn | |
| Example C-1 | 39 minutes | Yes | Yes | 80 | Off statins | Socks | Equivalent to |
| | | (auto key | (auto key | | for 2 weeks | worn | Example A |
| | | battery) | battery) | | | | (but with |
| | | | | | | | shorter imprint |
| | | | | | | | time (~ 1/10) |
| | | | | | | | but with |
| | | | | | | | battery); |
| | | | | | | | Same 80 pound |
| | | | | | | | grip with 39 |
| | | | | | | | minute battery |
| | | | | | | | imprint as |
| | | | | | | | Example A |
| | | | | | | | imprinted 360 |
| | | | | | | | minutes |
| | | | | | | | without battery |
| Example C-2 | 43 minutes | Yes | No | 70 | Off statins | Socks | 12.5% lower |
| | | (auto key | | | for 2 weeks | worn | grip without |
| | | battery) | | | | | battery during |
| | | | | | | | test |
| Example D | 43 minutes | No | No | 70 | Off statins | Socks | 12.5% reduced |
| | | | | | for 2 weeks | worn | grip due to not |
| Example E | 51 minutes | Yes | No | 78 | Off statins | Bare feet | |
| | | (auto key | | | for 2 weeks | against | |
| | | battery) | | | | insole | |
| Example F | 52 minutes | Yes | Yes | 86 | Off statins | Bare feet | Effect of |
| | | (auto key | (auto key | | for 2 weeks | against | battery worn |
| | | battery) | battery) | | | insole | during test |
| | | | | | | | when insole |
| | | | | | | | was imprinted |
| | | | | | | | with battery |
| Control 5 | Retesting | No (no | Yes | 65 | Off statins | Socks | Presence of |
| | of Control | imprinting) | (auto key | | for 2+ | worn | battery during |
| | 3 on next | | battery | | weeks | | testing without |
| | day | | and iPhone) | | | | imprinted |
| | | | | | | | pattern causes |
| | | | | | | | decrease |
| | | | | | | | relative to |
| | | | | | | | Control 4 |
| Control 6 | Retesting | No (no | No | 77 | Off statins | Socks | |
| | of Control | imprinting) | | | for 2+ | worn | |
| | 4 on next | | | | weeks | | |
| | day | | | | | | |
| Example G | 52 minutes | Yes | No | 70 | Off statins | Socks | Confirmed |
| | | (auto key | | | for 2+ | worn | lower effect |
| | | battery) | | | weeks | | without EMF's |
| | | | | | | | during test |
| Example H | 52 minutes | Yes | Yes | 82 | Off statins | Socks | Effect of test |
| | | (auto key | (2 auto key | | for 2+ | worn | with imprint |
| | | battery) | battery) | | weeks | | batteries on |
| | | | | | | | tester |
| Example I | 52 minutes | Yes | Yes | 85 | Off statins | Socks | Effect of |
| | | (auto key | (2 auto key | | for 2+ | worn | adding iPhone |
| | | battery) | battery | | weeks | | off to batteries |
| | | | and iPhone | | | | in test |
| | | | off) | | | | |
| Example J | 52 minutes | Yes | Yes | 88 | Off statins | Socks | Imprinted, |
| | | (auto key | (2 auto key | | for 2+ | worn | battery-treated |
| | | battery) | battery | | weeks | | insoles are |
| | | | and iPhone | | | | increasingly |
| | | | on) | | | | energized by |
| | | | | | | | higher EMF |
| | | | | | | | (from Example |
| | | | | | | | H to Example I |
| | | | | | | | to Example J); |
| | | | | | | | highest (with |
| | | | | | | | batteries and |
| | | | | | | | iPhone on) |
| Control 7 | — | No (no | Yes | 75 | Off statins | Socks | Likely some |
| | | imprinting) | (iPhone | | for 2+ | worn | transfer to |
| | | | on) | | weeks | | control insoles |
| Control 8 | — | No (no | Yes | 71 | Off statins | Socks | |
| | | imprinting) | (2 auto key | | for 2+ | worn | |
| | | | battery | | weeks | | |
| | | | and iPhone | | | | |
| | | | on) | | | | |
| Control 9 | — | No (no | Yes | 75 | Off statins | Bare feet | Increased |
| | | imprinting) | (2 auto key | | for 2+ | against | relative to |
| | | | battery | | weeks | insole | Control 8 -- |
| | | | and iPhone | | | | consistent with |
| | | | on) | | | | distance from |
| | | | | | | | skin |
| Example K | 52 minutes | Yes | Yes | 80 | Off statins | Socks | iPhone on is |
| | | (auto key | (iPhone | | for 2+ | worn | similar to 2 |
| | | battery) | on; no | | weeks | | auto key |
| | | | keys) | | | | batteries |

### Example 11

This example determined the effect of imprinting with the regularizing device of the invention on the effect of two different nutritional/skin care formulations:
Anti-aging/Energy Capsules, commercially available from Dr. Michael Seidman (acetyl-L-Carnitine 600 mg; alpha lipoic acid 150 mg; Co-enzyme Q-10 90 mg; L-glutathione 60 mg); and
Neutrogena™ Anti-Aging Skin Cream (containing L-carnitine).

In a first control test, a Seidman's Anti-aging/Energy Capsule was applied with an adhesive backing to the skin of the test subject's right arm and then the test subject performed dynamometer grip tests. The capsule was found to increase grip strength from the control 60 pounds to 70 pounds (+16.7%) when contacted with the skin over the lower arm muscle. The increase peaked in 6.5 minutes and fell off rapidly in less than 30 minutes, with the capsule still in contact with the tester's right arm. The test was repeated by dumping the contents of the capsule on adhesive tape and adhering the tape to the tester's arm. A similar effect was found.

Three days later, control grip strength was 67+/−2 pounds, which may indicate some longer range residual effect of Seidman's Anti-aging/Energy Capsule when applied to the arm muscle, since control strength had been uniformly 60-62 pounds over the past year for the test subject. The tester waited seven days until his strength measurements returned to his normal control level of 60 pounds.

In a second control test, Neutrogena™ Anti-Aging Skin Cream (with L-carnitine only) was applied to the test subject's right arm and then the test subject performed dynamometer grip tests. Control grip was 60, 62, 62 pounds in three tests. Immediately after application of Neutrogena Anti-Aging cream to right arm muscle grip went up to 68 pounds and stayed at that level for three more tests over the next 4 minutes. At 8 minutes, grip went up to 70 pounds and stayed at that level for three more tests up to 13 minutes after cream application and with or without two key batteries in tester's pockets. After 28 minutes grip fell to 63 pounds with two batteries on tester. Neutrogena products contains only one ingredient, L-Carnitine, in common with Seidman's Formula A, that gave the same 70 pounds maximum grip when applied topically without any regularized device. This suggest that the L-Carnitine is the active ingredient in both, that affects the muscle by skin proximity. After 30 minutes, but with regularized belt added around arm muscle just below elbow, grip went up to 75 pounds.

In a third test, the test subject ingested two Seidman's Anti-aging/Energy Capsules and then the test subject performed dynamometer grip tests.

In each case, imprinting of the lower right arm sleeve with a regularizing device of the invention accelerated the effect of the nutritional or skin care formulation.

A lower right arm sleeve that was imprinted 3 hours in an office with a regularizing device of the invention, but without any battery on the fabric (without battery). Another sleeve was imprinted at the same time with an electronic car door opener on the fabric (with battery).

| | | EMF (battery) | |
|---|---|---|---|
| | Imprinting | device present | |
| | Time on Sleeve | during | Grip Strength |
| | (minutes) | imprinting? | (pounds) |
| Test A | 360 | No | 75 |
| Test B | 360 | Yes | 80 |

In Test A, grip strength increased to 75 pounds. In Test B, grip increased to 80 pounds, which is the usual maximum possible for this test subject. EMF device (battery)-driven imprinting seemed to increase the rate or level of grip increase.

The control grip strength was back to 60 pounds, as usual, seven days after contacting Seidman's Anti-aging/Energy Capsule to the lower arm muscle. After ingesting two Seidman's Anti-aging/Energy Capsules with 8 ounces of water, grip increased to 61 pounds in 20 minutes, 66 pounds after 1.5 hours, and to a maximum of 70 pounds after two hours, when two electronic car door openers were in the test subject's pockets. This was the same maximum as in the first control test above in this example. Ingestion caused grip to increase more slowly and the increase to last longer than in the skin contact test, 2 hours versus 5 minutes and <6.25 hours versus ½ hour, respectively. Tests were done both with and without batteries on the test subject after two hours. Without batteries grip strength remained at the 70 pounds maximum after 4 hours, and after 6.25 hours. Grip fell back to 60-62 pounds control by 21 hours without batteries. With batteries in pockets, grip dropped back to control in 6.25 hours. Therefore, the EMF of the battery seems to accelerate the depletion of the nutrients provided in Seidman's Anti-aging/Energy Capsules.

The nutrients and anti-oxidants in Seidman's Anti-aging/Energy Capsule increase grip strength quickly, but for a short time only after skin contact over the arm muscles. Some of them seem to have longer term, more persistent effects that increase more slowly, but to the same maximum of +16.7% (70 pounds) over hours or days rather than minutes.

Three hour imprinting with regularizing device having at least one non-metallic, non-conductive or semi-conductive, non-magnetic, and non-energized circuit in fabrics gives a 25% grip increase and battery-driven imprinting for the same time gives +33.3% grip increase to the maximum 80 pounds achievable by the specific test subject.

The imprinted fabric (imprinted in the presence of batteries) seems to accelerate the combined effect, and deplete the nutrient effect faster than the imprinted fabric (imprinted in the absence of batteries).

### Example 12

In this example, the effect of the imprinting method of the invention on the effect of cell nutrition experiments was determined. Control strength was higher than usual two days after ingestion of two Seidman's Anti-aging/Energy Capsules. The presence of direct current (DC) battery devices (such as an iPhone, cell phone, or electronic car door opener) in pockets of test subject reduced grip when the test subject was not contacting an imprinted component of the invention. A sleeve was imprinted with the regularizing device having at least one non-metallic, non-conductive or semi-conductive, non-magnetic, and non-energized circuit and then tested in the presence of DC batteries (from an iPhone and two electronic car door openers). Grip increased about 3× the control when an iPhone and two electronic car door openers were in pockets, versus when no DC devices are in pockets. A fabric imprinted with the regularizing device having at least one non-metallic, non-conductive or semi-conductive, non-magnetic, and non-energized circuit (where no EMF devices were present during the imprinting step) for the same time (3 hours) only increased grip half as much as an imprinted fabric (where an EMF device was present during the imprinting step). Ingestion of two more Seidman's Anti-aging/Energy Capsules increased grip about 5% when the iPhone and two car door openers were present but about twice as much without the iPhone and two car door openers in pockets, so the EMF devices (iPhone and two car door openers) retarded the initial grip increase by Seidman's Anti-aging/Energy Capsules nutrients without imprinting with the regularizing device. Three minutes after ingestion of the Seidman's Anti-aging/Energy Capsules, with the imprinted fabric (where an EMF device was present during the imprinting step), grip increased if the iPhone and two electronic car door openers in pockets but decreased if not. This indicates a 2× synergy of the imprinting method of the invention with Seidman's Anti-aging/Energy Capsules that may be due to a greater supply of cell nutrients available to fuel the cell activity driven by the imprinted fabric (when an EMF device was present during the imprinting step) when powered by the EMF devices in the test subject's pockets. The imprinted fabric (when an EMF device was present during the imprinting step) also gave the greatest grip increase 50 minutes after ingestion of Seidman's Anti-aging/Energy Capsules when the iPhone and two electronic car door openers were present.

### Example 13

In this example, the effect of imprinted sleeves in presence and absence of EMF devices (batteries) and the ingestion of Seidman's Anti-aging/Energy Capsules was determined.

The control average grip without any EMF devices two days after ingestion of the last Seidman's Anti-aging/Energy Capsules was again +7.5% (4.5 pounds) above the usual control grip, confirming there is a residual effect.

The next series of grip tests confirm that an iPhone and two electronic car door openers reduce hand grip strength by 5.7% before ingesting more Seidman's Anti-aging/Energy Capsules and with no imprinted components.

The battery-imprinted sleeve only increased grip by 6.25% (4 pounds) (without the iPhone and electronic car door openers), while it increased grip +19.7% (12 pounds) (with the iPhone and electronic car door openers). This confirms that the DC battery device EMF's enhance grip strength with fabric imprinted with the regularizing device of the invention.

The imprinted sleeve (without the iPhone and electronic car door openers during the imprinting step) only increased grip half as much (+9.8%) even with the iPhone and two electronic car door openers. This confirms that imprinting without an EMF device reduces the imprint effect all ways.

Immediately on ingestion of two Seidman's Anti-aging/Energy Capsules, unaided grip goes up 4.9% (with the iPhone and electronic car door openers during the imprinting step) and 9.4% (without the iPhone and electronic car door openers during the imprinting step). This suggests the EMF devices (batteries in the iPhone and electronic car door openers) retard the action of the Seidman's Anti-aging/Energy nutrients by half at first, or the devices reduce the grip by 8.6% at first ingestion.

Three minutes after ingestion the grip in the imprinted sleeve (with the iPhone and electronic car door openers during the imprinting step) dropped 3% (without the iPhone and electronic car door openers during the testing step), but increased 4% (with the iPhone and electronic car door openers during the testing step). This also indicates that the presence of the EMF devices (batteries in iPhone and electronic car door openers) during the imprinting step with the regularizing device of the invention activates or accelerates the cell energy activity that gives grip strength improvement.

The result of the above is that the sleeve imprinted in the presence of the iPhone and electronic car door openers gave +15.2% higher grip after ingestion of two Seidman's Anti-aging/Energy Capsules than without the iPhone and electronic car door openers during the imprinting step, while before ingestion the iPhone and two electronic car door openers only gave a +7.4% advantage.

The fabric imprinted in the absence of the iPhone and electronic car door openers during the imprinting step gave a slightly higher (+3%) grip strength than the fabric imprinted in the presence of the iPhone and electronic car door openers before ingestion of Seidman's Anti-aging/Energy Capsules, and increased +8.5% on ingestion of Seidman's Anti-aging/Energy Capsules, but dropped back −5.7% 20 minutes later. Without any imprinting by the regularizing device but in the presence of Seidman's Anti-aging/Energy Capsules, grip increased +12.5% on ingestion of Seidman's Anti-aging/Energy Capsules, but dropped back to 70 pounds in 15 minutes

Fifty minutes after ingestion of Seidman's Anti-aging/Energy Capsules all of the conditions without the EMF devices (batteries in iPhone and electronic car door openers) were at 77.5+/−0.5 pounds whether any imprinted fabric was present or not. The fabric imprinted in the presence of the iPhone and electronic car door openers also ended up at this level, although it came down from 80 pounds, 20 minutes after ingestion of Seidman's Anti-aging/Energy Capsules.

The fabric imprinted in the presence of the iPhone and electronic car door openers was the only one to increase grip to the 81 pounds level by the end of the test, 50 minutes after ingestion of Seidman's Anti-aging/Energy Capsules.

### Example 14

This example tests hamstring flexibility, as measured by on the Backsaver Sit and Reach™ tester. The results are shown in the following tables:

Sit and Reach Test Data

| Time | Measurements (cm) | | | | | Conditions |
|---|---|---|---|---|---|---|
| 8:00 AM | 10.50 | 11.50 | 12.75 | 13.50 | 12.25 | Control (1 leg |
| | | | | | | straight) |
| 8:00 AM | 9.00 | 9.75 | | | | Control (both legs |
| | | | | | | straight |
| 1:30 PM | 10.50 | 9.75 | | | | Control (1 leg |
| | | | | | | straight) |
| 1:30 PM | 11.75 | 13.50 | 15.25 | 15.75 | 15.75 | “O” belt (1 leg |
| | | | | | | straight) Invention |

Percent Increase Invention over Control

| | | | | | | |
|---|---|---|---|---|---|---|
| 8:00 AM | 10.50 | 11.50 | 12.75 | 13.50 | 12.25 | Control (1 leg |
| | | | | | | straight) |
| 1:30 PM | 11.75 | 13.50 | 15.25 | 15.75 | 15.75 | “O” belt (1 leg |
| | | | | | | straight) Invention |
| % | 11.90 | 17.40 | 18.51 | 17.00 | 28.57 | |
| increase | | | | | | |

average 18.67% increase

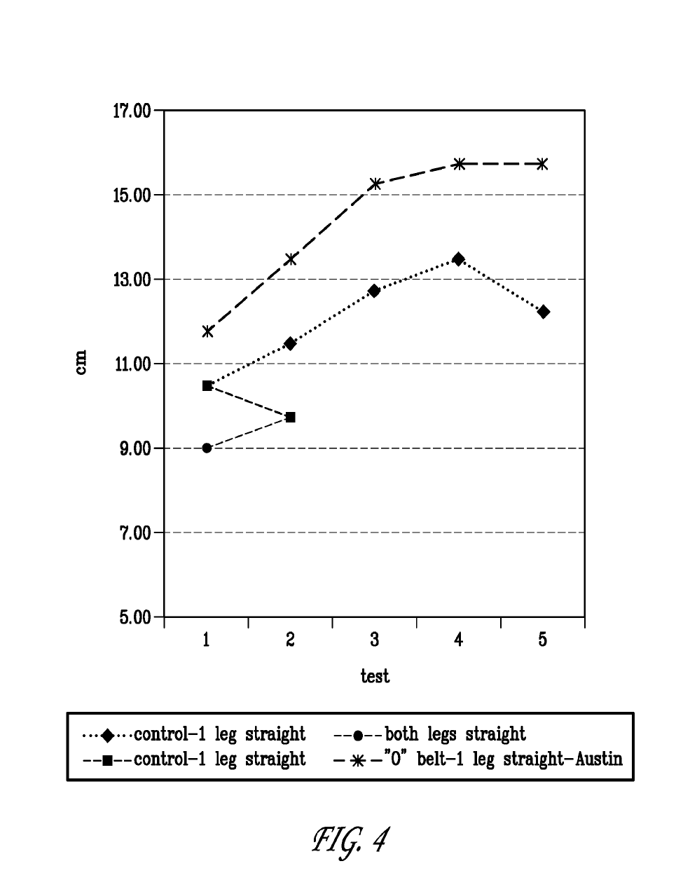

In FIG. 4, the lower curve is a control (no imprinted belt but with warm-up). A later test with two stretches long after cool down shows that initial flexibility is the same, or even lower. Then, a belt imprinted in accordance with the invention (for 30 minutes) was wrapped around the waist over shirt and undershirt. The upper curve, which runs 11.9% to 28.57% higher in reach flexibility, demonstrates the positive effect of the imprinted device versus the best that could be achieved with reach potentiation alone, even when warmed up. Flexibility increases slightly in the first four extensions, similar to the increase of grip strength due to stress potentiation (Example 1). Flexibility is higher after warm-up of the joint being stretched.

The data showed an increased stretch obtained in a Sit and Reach test of flexibility when wearing a Dri-release® web belt imprinted with the regularizing device of the invention in the presence of an electronic car door opener (from Audi) versus the same test series without such a belt. Physical therapy coaches use this standard test to assess the combined leg hamstring and back flexibility as people age and exercise. Warm-up usually gives greater flexibility, so the test subject did the control series without the imprinted belt right after a 10 minutes air-bike warm-up. The tests with the imprinted belt were done in the afternoon without any preliminary warm-up. A Back-Saver Sit-and Reach with only the right leg straight was used, to minimize the risk of pain or injury for the test subject.

The reach with the imprinted belt with no warm-up was from almost 12% to greater than 28% more for all five stretches attempted, with an average of almost +19% overall. These are significant improvements that are difficult to match by repeated exercises over period of weeks or months. Only one or two repetitions are usually done for an assessment, but repeated tests do give a stress-potentiation effect of increasing reach up to the fourth or fifth attempt as shown. The stretches done with the imprinted belt increased about a third more in the first two tries, and did not show a fatigue reduction in the fifth try as in the series of unassisted stretches.

### Example 15

This example determined the effect of imprinting with the regularizing device of the invention on a belt (imprinted component) with and without the presence of an EMF device and the effect of EMF devices alone on hand grip strength. The increases were less than when imprinted sleeves were worn directly over the arm muscles being tested, but were still significant.

Since the test subject stopped taking a statin every day, his right hand initial strength went up to 68 pounds with either Lafayette dynamometer. No. 1 was used below.

Test strengths were reduced to 60-65 pounds (reduced 4.4%-11.8%) in the presence of each of four different batteries or the iPhone without any clothing imprinted with the regularizing device of the invention. The test subject had typically seen about −5% grip strength effect with various battery-powered devices in pockets.

A Dri-release® web belt was imprinted for 30 minutes with a regularizing device comprising a non-metallic, non-conductive or semi-conductive, non-magnetic, and non-energized circuit in the presence of an electronic car door opener (from Audi) to produce an imprinted belt (imprinted component).

With the same electronic car door opener (from Audi) in the pants pocket, strength was increased 20.6% (68-82 pounds) with the imprinted belt replacing a leather belt over two shirt layers.

A Blackberry cellular telephone reduced strength almost 3% (to 66 pounds), but adding the electronic car door opener (from Audi) the imprinted belt increased grip almost 6%, for a 9% delta.

An electronic car door opener from Honda did not energize the imprinted belt as well as the electronic car door opener from Audi, except when its 3-volt battery was worn alone outside of its case.

A female tester with only 60 pounds right grip control strength, with or without a battery wristwatch, had a 30% higher grip (78 pounds) when wearing the imprinted belt.

| | Strength | |
|---|---|---|
| Description | (pounds) | Comments |
| No EMF device, Lafayette 1 (old) | 68 | Control (no EMF |
| | | device or |
| | | imprinted belt) |
| No EMF device, Lafayette 2 (new) | 68 | |

Following tested using Lafayette 1 and EMF devices as noted:
Individual batteries tested:

| | |
|---|---|
| D 1.5 volt battery | 65 |
| 9 volt battery | 64 |
| Honda 3 v button battery | 60 |
| Audi 1.5-3 v battery | 60 |

EMF devices tested:

| | |
|---|---|
| I-Phone turned on | 62 |
| I-Phone turned on w/Audi fob | 62 |
| D cell & 9-volt & H & A & I-phone | 64 |

Imprinted belt and various EMF devices tested:

| | | |
|---|---|---|
| Imprinted belt over shirts - no | 68 | |
| separate leather or fabric belt - | | |
| no EMF devices | | |
| Audi car door opener & imprinted | 82 | Since belt was |
| belt (Audi treated during imprinting) | | imprinted with Audi |
| | | car door opener, |
| | | the car door opener |
| | | may amplify the effect |
| Subaru car door opener & imprinted | 80 | |
| belt (Audi treated during imprinting) | | |
| 9-volt and imprinted belt (Audi | 74 | |
| treated during imprinting) | | |
| D-cell 1.5 v and imprinted belt (Audi | 68 | |
| treated during imprinting) | | |
| iPhone and imprinted belt (Audi | 60 | Negative - not |
| treated during imprinting) | | energizing or |
| | | amplifying the |
| | | imprinting effect |
| | | (preferable to use |
| | | same EMF source |
| | | during imprinting |
| | | step and |
| | | testing step) |
| Blackberry alone (no other EMF | 66 | |
| devices) | | |
| Blackberry and imprinted belt (Audi | 72 | |
| treated during imprinting) (“O” belt) | | |
| Honda battery out of case | 70 | |
| Honda battery out of case and | 82 | Honda battery |
| imprinted belt (Audi car door opener | | alone amplifies |
| present during imprinting) | | imprinting effect |
| | | as did Audi car |
| | | door opener |
| Honda car door opener and | 70 | |
| imprinted belt (Audi car door opener | | |
| present during imprinting) | | |
| Honda car door opener and | 70 | Repeated - same |
| imprinted belt (Audi car door opener | | results - Car door |
| present during imprinting) | | opener may shield |
| | | battery from |
| | | having effect |
| Control - no EMF devices | 60 | |
| Battery watch on right wrist | 60 | |
| Battery watch on right wrist and | 78 | Battery watch |
| imprinted belt (Audi car door opener | | amplifies |
| present during imprinting) | | imprinting effect |

### Example 16

In this example, the effect of magnets on the strength was tested. In prior grip strength testing, battery-powered or 60 cycle alternating current EMF devices showed an enhancement of the imprinting effect of the invention. However, in earlier testing, magnets did not enhance imprinting effect of invention. This example was repeated. As previously found, both magnets and ferrites reduced strength by about 7.5%.

The testing was repeating using the Lafayette grip strength tester in the right hand, where the male test subject had two battery-operated door key openers in pocket. Woven cotton belts were imprinted. The test results are shown below:

| | | Imprinting of | | | |
|---|---|---|---|---|---|
| | | woven cotton | Leather belt | | |
| | | belt with | with metal | | |
| | | regularizing | buckle worn | | Grip |
| | | device of | by test | Magnetic | strength |
| Test | Description | invention | subject? | belt | (pounds) |
| A | Control test grip | No | Yes | No | 65 |
| B | Control test grip | No | No | No | 60 |
| C | “X” (untreated) | No | No | Yes | 62 |
| | belt - worn over | | | | |
| | shirt | | | | |
| D | “MAG” (magnets | Yes | No | Yes | 62 |
| | & imprinted with | | | | |
| | pattern of | | | | |
| | invention) belt | | | | |
| | over shirt | | | | |
| E | “O” belt - worn | Yes | No | No | 76 |
| | over shirt | | | | |

Magnetically treated belt (Tests C and D) seemed to have little influence on strength; weaker than controls (Tests A and B). The battery-imprinted belt without magnetic treatment (Test E) improved grip strength 16.9% over control.

### Example 17

It is known that stress potentiation causes strength to increase with the number of test cycles until muscle fatigue overcomes the potentiation effect. In testing, the test subject observed that static isometric tests did not give as much strength increase with imprinting method of the invention as the moving, isotonic leg extension test where constant weights were lifted by a lower leg eccentric motion.

The test subject began leg extension tests on the uninstrumented, Cybex isotonic (constant load with movement) leg extension machine used for exercise training at most sites. The table below summarizes the isotonic leg extension tests using imprinted woven cotton belts versus an identical untreated belt. The test subject had two electronic car door opener in his pocket and no belt on trousers.

| Description | Test Results** | Comments |
|---|---|---|
| No belt - control | 5, 6, 6.5, 7, 7.5, 8 8.5 but | Felt as difficult at 5 as |
| | not 9 (partial lift only) | at 9 - stress potentiation |
| “X” belt - | not 9, 8.5 OK | No difference versus no |
| Not imprinted | | belt |
| “O” | 9 OK, 9.5 OK, 10 OK, | Imprinted component |
| Imprinted belt | not 10.5 (partial lift only) | highest; 17.6% better |
| | | than first control of 8.5 |
| | pause while others used | |
| | machine | |
| 60 cps imprinted | 10 no, 9.5 no, 9 OK, 9.5 | 25% better than 2nd |
| treated belt | OK, 10 no | control of 8.0 |
| No belt - control | 9 no, 8 OK, 8.5 no | Not quite as good as |
| | | first control (fatigue?) |

*Test subject could use leg extension machine to lift 125 pounds with imprinted belt and only 106.25 pounds (or less) with the control or untreated belt

| Cybex Plates** | |
|---|---|
| (pounds) | Pounds |
| 0.5 | 6.25 |
| 5 | 62.5 |
| 6 | 75 |
| 7 | 87.5 |
| 8 | 100 |
| 9 | 112.5 |
| 10 | 125 |
| 11 | 137.5 |
| 12 | 150 |

The strength increase with the imprinted belt (in the presence of an electronic car door opener from Audi) was 17.6% versus the initial controls, and 25% versus the final no belt control, where both test and control were likely affected by the beginning of muscle fatigue. The imprinted belt was imprinted for 30 minutes, using the same (in the presence of an electronic car door opener from Audi) as was in the test subject's pocket during all of the leg extensions. This has given the maximum strength improvement in previous tests.

Another belt was imprinted using a 60 cps AC cord connected to a 120V wall socket. The test subject was only able to lift 118.75 pounds maximum, or 18.75% more weights than the final control using this belt. This may reflect fatigue or that no 60 cps field was near enough to the test subject to energize the belt.

### Example 18

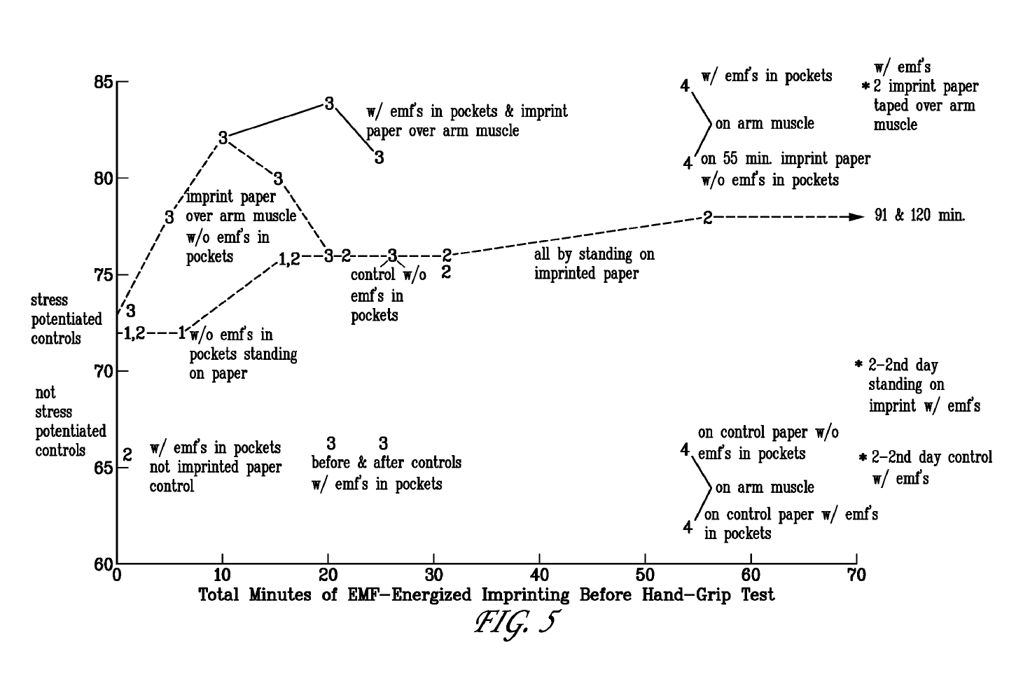

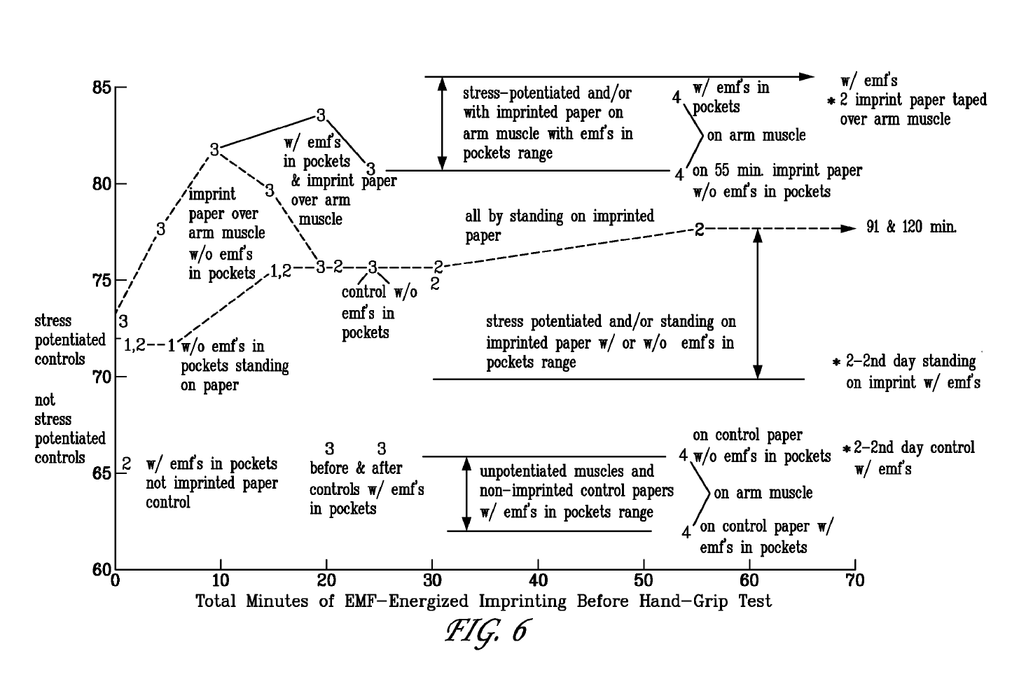

A hand grip test was conducted. The results are shown in FIGS. 5 and 6. All of the imprinted papers were done with the 1.5+V button battery car openers and iPhone energizing the imprinting process for the times shown on the bottom scale. Tests were done either standing with bare feet on the papers, or with papers taped to the bare skin of the arm.

The data show clearly that the maximum improvement (to 83.5+/−2.5 pounds) is when the imprinted paper is taped directly over the arm muscle being stressed, with the same car openers used to energize the imprinting worn in the pockets of the test subject. The stress-potentiated control strengths were 72 pounds, so the hand grip improvement was 16% over the stress-potentiated control. The unpotentiated controls were all 64+/−2 pounds with EMF's in the pockets, so the improvement over an unpotentiated grip with a 1.5 V button batteries in pockets was 30.5%.

Experiment 2 showed an improvement from the 72 pound control grip to 76 pounds (+5.6%) after 16 minutes of imprinting time, and when testing by standing on the papers. That effect stayed constant through 31 minutes of imprinting. Sometime between 31 and 56 minutes a further improvement occurred to 78 pounds (+8.3%). No further standing test improvement occurred up to 120 minutes of imprinting. Taping the imprinted paper to the right arm muscle just below the elbow, gave a further improvement to 86 pound grip, for a 19.4% improvement over the stress-potentiated control.

Therefore, Experiment 3 was started with a fresh paper, but taping the imprinted paper around the right arm muscle just below the elbow for testing. As can be seen, the grip improvement went up from the 73 pound control to 78 and 82 pounds (+12.3%) in the first 10 minutes of imprinting. Grip began to go down after 15 and 20 minutes of imprinting to the same maximum (76 pounds) of the standing tests, when the EMF used to imprint the paper was not put back in the pocket of the tester. Putting the two car openers and the iPhone back in the pockets caused grip to go up to 84 pounds (+15.1%) immediately. It then dropped back to 81 pounds after another 5 minutes of imprinting.

Experiment 4 was done the next day, after a further 30 minutes of imprinting of the same paper used in Experiment 3. This indicated that it was not the time of imprinting that caused the effect to drop off, but probably the exhaustion of whatever is energized within the muscle cells, since the 55 minute imprint gave about the same maximum grip with the EMF's as the 20 minute imprinting of the previous day on the same paper. Contacting the paper to the bottom of the feet, far from the arm muscle being stressed gives less improvement, but also seems to not exhaust the muscle cells as fast as local contact.

### Example 19

A comparison was made between the effect of the Q-Link Classic pendant (containing coiled copper wire) and the regularizing device of the invention in a hand grip test using Lafayette hand grip tester.

For the first set of comparisons, the testing was done by placing the respective devices over certain body parts without first imprinting a component, as a control test. The tester had two electronic car door openers and cell phone in pockets:
The regularizing device of the invention positioned over the breastbone gave a 13.6% higher grip (68 vs. 60 pounds) than the Q-Link pendant so positioned, and 12.7% higher grip (71 vs. 63 pounds) when both are positioned over the right lower arm muscle.
Removal of the plastic outer casing of the Q-Link gave a slightly (+2.7%) higher grip (64.7 vs. 63 pounds). Complete separation of the copper coil from the outer case and the crystal-containing central plastic gave the greatest increase (74 vs. 63 pounds; 17.5%).

For the second set of comparisons, T-shirt fabric squares were imprinted with the two devices or component parts of the devices and then attached to the right forearm of the tester. The tester had two electronic car door openers and cell phone in pockets during the testing. The results are shown in the table below:

| | Results | Average | |
|---|---|---|---|
| Description | (pounds) | (pounds) | Comments |
| Control - stocking feet, | 66 | | |
| no cloth - zeroed | | | |
| Control - stocking feet, | 60 | | It did make a 4-6 pound |
| no cloth - below zero | | | difference if starting |
| | | | below zero |
| Control - stocking feet, | 64 | 63.3 | |
| no cloth - zeroed | | | |
| Sample 1 - untreated | 64 | | |
| control fabric | | | |
| Sample 1 - untreated | 65 | 64.5 | |
| control fabric | | | |
| Sample 5 - Q-Link coil | 72 | | |
| w/battery | | | |
| Sample 5 - Q-Link coil | 72 | 72 | Q-link coil (72) is 11.7% |
| w/battery | | | better than 64.5 control; |
| | | | coil (72) is 13.7% better |
| | | | than 63.3 average of no |
| | | | cloth control |
| Regularizing device of | 80 | | |
| invention attached to | | | |
| sleeve w/battery | | | |
| Regularizing device of | 74 | | |
| invention attached to | | | |
| sleeve w/battery | | | |
| Regularizing device of | 76 | 76.7 | Regularizing device of |
| invention attached to | | | invention (76.7) is 21.1% |
| sleeve w/battery | | | better than 63.3 average |
| | | | of no cloth control |
| | | | Regularizing device of |
| | | | invention (76.7) is 6.5% |
| | | | better than Q-Link coil |
| | | | w/battery in Sample 5 (72) |
| | | | Regularizing device of |
| | | | invention (76.7) is 17.8% |
| | | | better than cloth control |
| | | | (64.5) |
| Control | 64 | | |
| Sample 8 -Duracel | | | |
| battery | | | |
| Control | 65 | 64.5 | Same results as untreated |
| Sample 8 -Duracel | | | control fabric |
| battery | | | |
| Sample 4 - Q-Link coil | 74 | | |
| only | | | |
| Sample 4 - Q-Link coil | 72 | 73 | Only slightly better than |
| only | | | coil w/battery in Sample 5 |
| Sample 7 - clear center | 75 | | |
| w/crystals of Q-Link | | | |
| device; w/Lexus | | | |
| electronic car door | | | |
| opener | | | |
| Sample 7 - clear center | 75 | 75 | Crystals w/battery are |
| w/crystals of Q-Link | | | 2.7% better than coil |
| device; w/Lexus | | | alone (73) |
| electronic car door | | | Crystals w/battery are |
| opener | | | 4.1% better than coil w/ |
| | | | battery(72) |
| Sample 6 - clear center | 70 | | |
| (crystals) no battery | | | |
| Sample 6 - clear center | 70 | 70 | Crystals no battery (70) |
| (crystals) no battery | | | is a 6.6% decrease over |
| | | | crystals w/battery (75) |

As can seen comparing Samples 4 and 5, the use of a 3V battery Honda car opener to do a 30 minute imprinting with the copper coil of a Q-Link pendant does not make much difference (72 vs. 73 pounds) in the grip strength with the resulting fabrics taped to the right elbow. This has been a consistent finding that the conductive coil does not benefit from an EMF device during the imprinting step. However, the copper coil does imprint the fabric about the same as the non-conductive pattern of the regularizing device of the invention. However, the clear plastic, crystal-containing center extracted from the Q-Link pendant gave +7.1% higher grip (75 vs. 70 pounds) when energized with a +3 V Lexus electronic car door opener.

### Example 20

The effect on hand grip strength of the ingestion of Resveratrol capsules contain 100 mg Polygonum cuspidatum root (trans-3,5,4′-trihydroxystilbene) was tested using Lafayette hand grip tester (using right hand of tester), where the tester wore a cloth belt imprinted with the regularizing device of the invention in the presence of electronic car door opener, for some of the tests, as noted below. The test results are shown in the table below:

| | | | |
|---|---|---|---|
| Weight | Time | Elapsed Time | Test Conditions and Comments |

Day 1

| | | |
|---|---|---|
| 60 | | control w/two electronic door |
| | | openers |
| 54 | | control w/two electronic door |
| | | openers |
| 60 | | control w/two electronic door |
| | | openers |
| 72 | | took Reservatrol capsule |
| 76 | +10 minutes | |

Day 2

| | | | |
|---|---|---|---|
| 66 | 9:00 AM | | |
| 66 | 10:00 AM | | |
| | 10:40 AM | | Took capsule of Reversatrol |
| 76 | | | Immediately |
| 74 | 10:42 AM | +2 | |
| 74 | 10:45 AM | +5 | |
| 80 | 10:50 AM | +10 | |
| 72 | 10:55 AM | +15 | |
| 72 | 11:00 AM | +20 | |
| | | | Effect may be cumulative so test |
| | | | again later |
| 80 | 11:05 AM | +25 | w/o two electronic door openers |
| 73 | 11:10 AM | +30 | w/two electronic door openers |
| 76 | 11:15 AM | +35 | w/two electronic door openers |
| 80 | 11:17 AM | +37 | w/o two electronic door openers |
| | | | w/imprinted component |
| 75 | 11:20 AM | +40 | w/imprinted component |
| 74 | 11:25 AM | +45 | w/imprinted component |
| 69 | 11:30 AM | +50 | w/imprinted component |
| 67 | 11:35 AM | +55 | nothing - control |
| 67 | 11:40 AM | +60 | w/two electronic door openers |
| 68 | 12:00 AM | +80 | nothing - control |
| 66 | 5:15 PM | +6 hr 35 | nothing - control |
| | | minutes | |
| 64 | 5:25 PM | +6 hr 45 | w/o two electronic door openers |
| | | minutes | |
| 76 | 5:28 PM | | w/two electronic door openers |
| | | | w/imprinted component |
| 66 | 5:30 AM | | w/o two electronic door openers |
| | | | w/imprinted component |
| 64 | 5:32 PM | | nothing - control |
| 60 | 8:30 AM | | nothing - control |
| 68 | 8:45 PM | | w/two electronic door openers |
| | | | w/o imprinted component |
| 71 | 8:55 PM | | nothing - control |

Day 3

| | | |
|---|---|---|
| 56 | 6:30 AM | nothing - control |
| 63 | 7:50 AM | nothing - control; after exercising |

The control grip strength just before taking each capsule went up +13.8% from the first day (58 pounds) to the second day (66 pounds). This is likely the residual effect of the Resveratrol on control strength after −24 hours when only two hand grip exertions were made in that period.

The grip strengths immediately after taking each capsule were 72 and 76 pounds (+24% and +15.2% respectively).

The next grip strengths decreased 2 pounds in a morning and afternoon series of tests on the 2nd day (−2.6% and −3%). A pattern of slight decrease and then sharp increase (+8% and +18.8%) in strength was seen within respective 1 and 5 hour test series after ingestion of the second capsule on Day 2.

Maximum grip declined from 80 to 76 to 71 pounds at 1 hour, 5 hour, and 8 hour intervals after the second capsule, or −5% to −6.6% declines.

Resveratrol seems to be activated by physical exertion to give a burst of instant strength that then falls off just as rapidly until re-activated by further exertion. The overall effect gradually goes down over the eight hour period currently tested when no further capsules are ingested. The control grip strength was increased on the third day after an exercise period, as shown in the data.

### Example 21

A group of 6 subjects was tested for flexibility in the stretch and reach box test. Each subject first measured flexibility with a control belt with electronic auto key with battery in pocket (HB), followed by a test belt imprinted with pattern of the invention with electronic auto key with battery in pocket (FB), and then followed by a new control belt with electronic auto key with battery in pocket (GB). The results are shown in the table below:

| | | | | | | Imprinted | | | | |
|---|---|---|---|---|---|---|---|---|---|---|
| | | | | | | belt of | | | | |
| | Beltless | % | Control | % | Control | invention | Control | | | |
| | Control | Increase | (cm) | Increase | (cm) | (cm) | (cm) | | | |
| | (cm) | of trial | “E” | control | “G” | “F” | “E” | Age | | |
| ID | trial | to control | belt | to control | belt | belt/S | belt | (year) | Gender | Comments |
| 100 | 16.5 | 9.1% | 18 | 11.1% | 20 | 20.5 | 18 | 47 | M | again, best |
| | | | | | | | | | | with |
| | | | | | | | | | | Invention/ |
| | | | | | | | | | | E belts test |
| | | | | | | | | | | identical |
| 101 | 15.5 | 29.0% | 20 | 0.0% | 20 | 23.75 | | 39 | F | |
| 103 | 25.25 | 3.0% | 26 | 7.7% | 28 | 26 | 24 | 28 | M | Wearing |
| | | | | | | | | | | Phillies |
| | | | | | | | | | | Phiten |
| | | | | | | | | | | necklace |
| 103 | | | 27 | 1.9% | 27.5 | 27.25 | 28 | 28 | M | Without |
| | | | | | | | | | | Phillies |
| | | | | | | | | | | Phiten |
| | | | | | | | | | | necklace |
| 112 | 30.00 | 8.3% | 32.50 | −3.1% | 31.50 | 32.00 | | 52 | M | warmed |
| | | | | | | | | | | up; |
| | | | | | | | | | | claimed |
| | | | | | | | | | | sore back; |
| | | | | | | | | | | fairly |
| | | | | | | | | | | consistent |
| | | | | | | | | | | w controls |
| 105 | 29.00 | 4.3% | 30.25 | 0.0% | 30.25 | 31.50 | 31.00 | 42 | M | hurt |
| | | | | | | | | | | shoulder |
| | | | | | | | | | | with |
| | | | | | | | | | | reaching; |
| | | | | | | | | | | “tight” |
| | | | | | | | | | | rainy day, |
| | | | | | | | | | | 4:25 pm |

Seventy five percent of the subjects experienced a decrease in flexibility when going from test belt imprinted with pattern of the invention with a 3 volt battery attached to the belt (FB) to a new control belt with a 3 volt battery attached to the belt (GB).

### Example 22

A group of 25 subjects was tested for flexibility in the stretch and reach box test. Each subject first measured flexibility with a control belt with a 3 volt battery attached to the belt (HB), followed by a test belt imprinted with pattern of the invention with a 3 volt battery attached to the belt (FB), and then followed by a new control belt with a 3 volt battery attached to the belt (GB). The results are shown in the table below:

| | | | | | | | | | “E” belt | | | |
|---|---|---|---|---|---|---|---|---|---|---|---|---|
| | “HB” belt | | “FB” belt | | “GB” belt | | | | (no | | | |
| ID | (cm) | | (cm) | | (cm) | HB | FB | GB | battery) | Age | Gender | Comments |
| 218 | 18.00 | −8.3% | 16.50 | −1.5% | 16.25 | | | | | 43 | m | sore R ligament |
| | | | | | | | | | | | | with bandage; |
| | | | | | | | | | | | | count of 6 is too |
| | | | | | | | | | | | | long to hold; |
| | | | | | | | | | | | | was #120 |
| 219 | 22.00 | 2.3% | 22.50 | −6.7% | 21.00 | | | | | 68 | m | |
| 220 | | | 15.00 | 16.7% | 17.50 | 15.50 | | | | 47 | m | was 100; took |
| | | | | | | | | | | | | HB out of order: |
| | | | | | | | | | | | | 2nd test was |
| | | | | | | | | | | | | highest |
| 221 | 17.5 | 2.9% | 18 | 0.0% | 18 | | | | | 67 | m | the F belt was |
| | | | | | | | | | | | | slightly above |
| | | | | | | | | | | | | the 18 but less |
| | | | | | | | | | | | | than 18.25 cm |
| 222 | 16.25 | 24.6% | 20.25 | −13.6% | 17.50 | | | | | 39 | f | was 101 |
| 223 | 30.00 | 5.0% | 31.50 | 11.1% | 35.00 | | 35.5 | 35.5 | | 65 | f | Person thought |
| | | | | | | | | | | | | that reading was |
| | | | | | | | | | | | | “38” instead of |
| | | | | | | | | | | | | 31.5 so did more |
| | | | | | | | | | | | | testing; was |
| | | | | | | | | | | | | #211 on |
| | | | | | | | | | | | | previous testing |
| 223 | | | 34.50 | −1.4% | 34.00 | 34.25 | | | 34.25 | 65 | f | very consistent |
| | | | | | | | | | | | | set of reach |
| | | | | | | | | | | | | distances |
| 224 | 22.25 | 12.4% | 25.00 | 7.0% | 26.75 | | | | | 18 | m | slides too fast, |
| | | | | | | | | | | | | tried counting, |
| | | | | | | | | | | | | starts back from |
| | | | | | | | | | | | | slider; was 203, |
| | | | | | | | | | | | | 209 |
| 115 | 28.00 | 7.1% | 30.00 | −5.0% | 28.50 | | | | | 56 | f | warmed up 10 |
| | | | | | | | | | | | | min on bike; 3rd |
| 101 | 19.00 | 0.0% | 19.00 | 15.8% | 22.00 | | 23.00 | | | 39 | f | 1st FB - |
| | | | | | | | | | | | | shoulders sore |
| | | | | | | | | | | | | from |
| | | | | | | | | | | | | sunburn; 4th |
| | | | | | | | | | | | | time |
| 204 | 17.50 | 8.6% | 19.00 | −10.5% | 17.00 | | | | | 47 | m | easy, breathe in; |
| | | | | | | | | | | | | was #100 |
| 203 | 16.00 | 28.1% | 20.50 | 6.1% | 21.75 | | | | | 18 | m | |
| 205 | 47.00 | −3.2% | 45.50 | 2.7% | 46.75 | | | | | 47 | f | warmed up; was |
| | | | | | | | | | | | | 121 |
| 120 | 16.50 | −1.5% | 16.25 | 7.7% | 17.50 | | | | | 43 | m | 3rd time |
| 202 | 34.50 | 0.0% | 34.50 | −1.4% | 34.00 | | | | | 44 | m | |
| 206 | 37.00 | 8.1% | 40.00 | −1.3% | 39.50 | | | | | 48 | f | |
| 207 | 21.00 | 2.4% | 21.50 | 4.7% | 22.50 | | | | | 39 | f | #101 previously |
| 208 | 31.00 | 4.8% | 32.50 | 2.3% | 33.25 | | | | | 33 | f | |
| 209 | 25.50 | 12.7% | 28.75 | 2.6% | 29.50 | | | | | 18 | m | #203 previous |
| | | | | | | | | | | | | test; fast slide; |
| | | | | | | | | | | | | tried to beat |
| | | | | | | | | | | | | yesterday's |
| | | | | | | | | | | | | numbers, even |
| | | | | | | | | | | | | though told that |
| | | | | | | | | | | | | we were only |
| | | | | | | | | | | | | testing the |
| | | | | | | | | | | | | differences; |
| | | | | | | | | | | | | previous nos. |
| | | | | | | | | | | | | were 16, 20.5, |
| | | | | | | | | | | | | 21.75; tested |
| | | | | | | | | | | | | GFH in that |
| | | | | | | | | | | | | order (switched |
| | | | | | | | | | | | | control order) |
| 210 | 30 | 0.8% | 30.25 | 1.7% | 30.75 | | | | | 33 | m | |
| 211 | 30.50 | 6.6% | 32.50 | 6.2% | 34.50 | | | | 33.5 no | 65 | f | wanted to do a |
| | | | | | | | | | belt | | | “control” with |
| | | | | | | | | | | | | no belt; |
| | | | | | | | | | | | | explained one |
| | | | | | | | | | | | | belt was |
| | | | | | | | | | | | | “control”, but |
| | | | | | | | | | | | | she insisted |
| 212 | 21.75 | 3.4% | 22.50 | −17.8% | 18.50 | | | | | 66 | f | trouble with |
| | | | | | | | | | | | | long artificial |
| | | | | | | | | | | | | fingernails |
| 214 | 29.00 | 3.4% | 30.00 | 0.8% | 30.25 | | | | | 75 | f | insisted on test |
| | | | | | | | | | | | | reach |
| 215 | 27.50 | 2.7% | 28.25 | 3.5% | 29.25 | | | | 29.5 “FB” | 28 | m | no Phiten |
| | | | | | | | | | retest | | | |
| 216 | 23.00 | | 28.5/24.5 | | 25.50 | | | | | 71 | f | says R knee may |
| | | | | | | | | | | | | have bent on |
| | | | | | | | | | | | | FB, so retested |
| | | | | | | | | | | | | it |

Seven subjects tested higher on the test belt imprinted with the pattern of the invention with a 3 volt battery attached to the belt than either control belt. Eight four percent of the subjects wearing the test belt imprinted with the pattern of the invention with a 3 volt battery attached to the belt tested higher than on the first control belt.

When ranges are used herein for physical properties, such as molecular weight, or chemical properties, such as chemical formulae, all combinations, and subcombinations of ranges specific embodiments therein are intended to be included.

The disclosures of each patent, patent application, and publication cited or described in this document are hereby incorporated herein by reference, in their entirety.

Those skilled in the art will appreciate that numerous changes and modifications can be made to the preferred embodiments of the invention and that such changes and modifications can be made without departing from the spirit of the invention. It is, therefore, intended that the appended claims cover all such equivalent variations as fall within the true spirit and scope of the invention.

1. A method of reducing the distortion of the electromagnetic field associated with a subject caused by an electromagnetic field from an external source, comprising the step of:
contacting a regularizing device to a component selected from the group consisting of a garment, a linen, a floor covering, or a combination thereof for a period of time sufficient to imprint said component to produce an imprinted component; and
contacting said imprinted component with said subject;
wherein said regularizing device comprises at least one non-metallic, non-conductive or semi-conductive, non-magnetic, and non-energized circuit.

2. A method of claim 1, further comprising the step of:
removing said regularizing device from said component prior to said contacting said imprinted component with said subject.

3.-6. (canceled)

7. A method of claim 1,
wherein said circuit comprises:
a substrate; and
a printed geometric pattern or shape on said substrate.

8. A method of claim 7,
wherein said printed geometric pattern or shape is not visually detectable by the unaided human eye.

9. A method of claim 7,
wherein said printed geometric pattern or shape is a concentric set of curved open-ended lines.

10. A method of claim 7,
wherein said printed geometric pattern or shape is a spiral pattern.

11. A method of claim 10,
wherein said spiral pattern follows the Golden spiral or a Fibonacci spiral.

12. A method of claim 7,
wherein said printed geometric pattern or shape is formed from at least one polymeric composition.

13. A method of claim 12,
wherein said printed geometric pattern or shape is made using an ink jet printer.

14.-16. (canceled)

17. A method of increasing strength of a muscle of a subject during use, comprising the step of:
contacting a regularizing device to a component selected from the group consisting of a garment, a linen, a floor covering, or a combination thereof for a period of time sufficient to imprint said component to produce an imprinted component; and
contacting said imprinted component to said subject during said use of said muscle;
wherein said regularizing device comprises at least one non-metallic, non-conductive or semi-conductive, non-magnetic, and non-energized circuit.

18.-32. (canceled)

33. A method of increasing the rate of stress potentiation of a subject during a physical activity, comprising the step of:
contacting a regularizing device to a component selected from the group consisting of a garment, a linen, a floor covering, or a combination thereof for a period of time sufficient to imprint said component to produce an imprinted component; and
contacting said imprinted component to said subject during said physical activity;
wherein said regularizing device comprises at least one non-metallic, non-conductive or semi-conductive, non-magnetic, and non-energized circuit.

34.-48. (canceled)

49. A method of improving stability of a subject during a physical activity, comprising the step of:
contacting a regularizing device to a component selected from the group consisting of a garment, a linen, a floor covering, or a combination thereof for a period of time sufficient to imprint said component to produce an imprinted component; and
contacting said imprinted component with said subject during said physical activity;
wherein said regularizing device comprises at least one non-metallic, non-conductive or semi-conductive, non-magnetic, and non-energized circuit.

50.-64. (canceled)

65. A method of improving flexibility of a subject during a physical activity, comprising the step of:
contacting a regularizing device to a component selected from the group consisting of a garment, a linen, a floor covering, or a combination thereof for a period of time sufficient to imprint said component to produce an imprinted component; and
contacting said imprinted component with said subject during said physical activity;
wherein said regularizing device comprises at least one non-metallic, non-conductive or semi-conductive, non-magnetic, and non-energized circuit.

66.-80. (canceled)

81. A method of improving sleep in a subject, comprising the step of:
contacting a regularizing device to a component selected from the group consisting of a garment, a linen, a floor covering, or a combination thereof for a period of time sufficient to imprint said component to produce an imprinted component; and
contacting said imprinted component with said subject while said subject attempts to fall asleep, is sleeping, or a combination thereof;
wherein said regularizing device comprises at least one non-metallic, non-conductive or semi-conductive, non-magnetic, and non-energized circuit.

82.-96. (canceled)

97. A device for imprinting an object selected from the group consisting of a garment, linen, floor covering, and combinations thereof, comprising:
at least one non-metallic, non-conductive or semi-conductive, non-magnetic, and non-energized circuit;
wherein said circuit comprises:
a substrate; and
a printed geometric pattern or shape on said substrate;
wherein said device reduces the distortion of the electromagnetic field associated with a subject in contact with said object caused by an electromagnetic field from an external source.

98. A device of claim 97,
wherein said printed geometric pattern or shape is not visually detectable by the unaided human eye.

99. A device of claim 97,
wherein said printed geometric pattern or shape is a concentric set of curved open-ended lines.

100. A device of claim 97,
wherein said printed geometric pattern or shape is a spiral pattern.

101. A device of claim 100,
wherein said spiral pattern is a Golden spiral or a Fibonacci spiral.

102. A device of claim 97,
wherein said printed geometric pattern or shape is formed from at least one polymeric composition.

103. A device of claim 97,
wherein said printed geometric pattern or shape is made using an ink-jet printer.

104. (canceled)

105. A device of claim 97,
wherein said device is a clothing hanger, a shoe tree, a shoe insole, or a garment bag.

106.-108. (canceled)

109. A system, comprising:
at least one device of claim 91; and
at least one device having an electromagnetic field.

110. A system of claim 109,
wherein said device having an electromagnetic field is a battery.

111. A garment, comprising:
a substrate; and
at least one non-metallic, non-conductive or semi-conductive, non-magnetic, and non-energized circuit comprising at least one printed geometric pattern or shape on said substrate;
wherein said garment reduces distortion of the electromagnetic field associated with a subject caused by an electromagnetic field from an external source, when said garment is worn by said subject; and
wherein said garment is other than jewelry.

112. A garment of claim 111,
wherein said garment comprises a plurality of said non-metallic, non-conductive or semi-conductive, non-magnetic, and non-energized circuit.

113.-121. (canceled)

122. A linen, comprising:
a substrate; and
at least one non-metallic, non-conductive or semi-conductive, non-magnetic, and non-energized circuit comprising at least one printed geometric pattern or shape on said substrate;
wherein said linen reduces the distortion of the electromagnetic field associated with a subject caused by an electromagnetic field from an external source, when said linen is in contact with said subject.

123.-132. (canceled)

133. A floor covering, comprising:
a substrate; and
at least one non-metallic, non-conductive or semi-conductive, non-magnetic, and non-energized circuit comprising at least one printed geometric pattern or shape on said substrate;
wherein said floor covering reduces the distortion of the electromagnetic field associated with a subject caused by an electromagnetic field from an external source, when said floor covering is in contact with said subject.

134.-135. (canceled)

136. A method of improving a biological effect in a subject, comprising the steps:
contacting a regularizing device to a component selected from the group consisting of a garment, a linen, a floor covering, or a combination thereof for a period of time sufficient to imprint said component to produce an imprinted component; and
contacting said imprinted component with said subject while said subject is administered, via ingestion or via contact to a body part of said subject, a composition comprising at least one organic compound selected from the group consisting of trans-3,5,4′-trihydroxystilbene, a levorotary organic compound, and a dextrorotary organic compound, provided said organic compounds have the same optical rotation;
wherein said regularizing device comprises at least one non-metallic, non-conductive or semi-conductive, non-magnetic, and non-energized circuit; and
wherein said biological effect is selected from the group consisting of:
an increase in strength of a muscle;
an increase in the rate of stress potentiation of a subject during a physical activity;
an improvement in stability of said subject during a physical activity;
an improvement in flexibility of said subject during a physical activity; and
an improvement in sleep in said subject.

137.-147. (canceled)

148. A method of improving a biological effect in a subject, comprising the steps:
contacting a regularizing device to a said subject while said subject is administered, via ingestion or via contact to a body part of said subject, a composition comprising at least one organic compound selected from the group consisting of trans-3,5,4′-trihydroxystilbene, a levorotary organic compound, and a dextrorotary organic compound, provided said organic compounds have the same optical rotation;
wherein said regularizing device comprises at least one non-metallic, non-conductive or semi-conductive, non-magnetic, and non-energized circuit; and
wherein said biological effect is selected from the group consisting of:
an increase in strength of a muscle;
an increase in the rate of stress potentiation of a subject during a physical activity;
an improvement in stability of said subject during a physical activity;
an improvement in flexibility of said subject during a physical activity; and
an improvement in sleep in said subject.

149.-154. (canceled)

155. A method of improving a biological effect in a subject, comprising the steps:
contacting a coil device to a component selected from the group consisting of a garment, a linen, a floor covering, or a combination thereof for a period of time sufficient to imprint said component to produce an imprinted component;
removing said coil device from said component prior to said contacting said imprinted component with said subject; and
contacting said imprinted component with said subject;
wherein said coil device comprises at least one metallic, non-energized circuit; and
wherein said biological effect is selected from the group consisting of:
an increase in strength of a muscle;
an increase in the rate of stress potentiation of a subject during a physical activity;
an improvement in stability of said subject during a physical activity;
an improvement in flexibility of said subject during a physical activity; and
an improvement in sleep in said subject.

156. A garment, comprising:
a substrate;
wherein said garment is a shirt, pants, underwear, outerwear, footwear, headwear, swimwear, belt, a glove, a headband, or a wristband;
wherein said garment increases strength or flexibility by at least about 2%, on average, in a group of at least five subjects, when said garment is worn by said subjects who have reached a maximum value in said strength or said flexibility without wearing said garment.

157. A garment of claim 156,
wherein said garment increases strength or flexibility by at least about 5%, on average, in a group of at least five subjects, when said garment is worn by said subjects who have reached a maximum stress potentiation without wearing said garment.

158. A garment of claim 156,
wherein said strength or flexibility decreases, on average, in said group, when said garment is no longer worn by said subjects.

159.-161. (canceled)
